(19) United States
(12) Patent Application Publication
(10) Pub. No.: US 2026/0161578 A1
(43) Pub. Date: Jun. 11, 2026

(54) ONE OR MORE STACKED MEMORY DEVICES AND A SEMICONDUCTOR SYSTEM

(71) Applicant: SK hynix Inc., Icheon-si Gyeonggi-do (KR)

(72) Inventor: Choung Ki SONG, Icheon-si Gyeonggi-do (KR)

(73) Assignee: SK hynix Inc., Icheon-si Gyeonggi-do (KR)

(21) Appl. No.: 19/381,928

(22) Filed: Nov. 6, 2025

Related U.S. Application Data
(60) Provisional application No. 63/826,691, filed on Jun. 19, 2025.

(51) Int. Cl. G06F 13/16; G06F 13/40

(52) U.S. Cl. CPC G06F 13/1678; G06F 13/1689; G06F 13/4068

(57) ABSTRACT

A semiconductor system includes a first HBM device comprising a first physical area and a second physical area. The semiconductor system includes a second HBM device comprising a third physical area and a fourth physical area and a process circuit electrically connected to the first physical area. The second physical area of the first HBM device and the third physical area of the second HBM device are electrically connected, and the fourth physical area is deactivated.

### CROSS-REFERENCE TO RELATED APPLICATION

The present application claims benefit under 35 U.S.C. § 119(e) to U.S. Provisional Application No. 63/826,691, filed on Jun. 19, 2025, in the United States Patent and Trademark Office, the entire contents of which application is incorporated herein by reference.

### BACKGROUND

### 1. Technical Field

The present disclosure generally relates to a memory device, and more particularly, to one or more stacked memory devices related to heat.

### 2. Related Art

Recently, stacked memory systems such as high bandwidth memory (HBM) devices are used in a wide range of applications due to their high bandwidth and energy efficiency. Unlike conventional memory systems that use parallel data buses, the stacked memory system includes a stacked memory device including a base chip and a plurality of memory chips interconnected by through silicon vias (TSVs). The stacked memory device includes a physical interface, such as a physical layer to communicate with a processor. The physical layer is designed for high-speed data transmission and efficient communication.

### SUMMARY

In an embodiment, a semiconductor system includes a first HBM device comprising a first physical area and a second physical area, a second HBM device comprising a third physical area and a fourth physical area and a process circuit electrically connected to the first physical area, wherein the second physical area of the first HBM device and the third physical area of the second HBM device are electrically connected, and the fourth physical area is deactivated.

In an embodiment, a semiconductor system includes a first HBM device, comprising a first physical area comprising a first group of physical layers and a second group of physical layers and a second physical area comprising a third group of physical layers and a fourth group of physical layers and a second HBM device, comprising a third physical area comprising a fifth group of physical layers and a sixth group of physical layers and a fourth physical area comprising a seventh group of physical layers and an eighth group of physical layers, wherein the first to eighth groups of physical layers are selectively activated.

### BRIEF DESCRIPTION OF THE DRAWINGS

FIG. 1 is a block diagram illustrating a construction of a semiconductor system according to an embodiment of the present disclosure.

FIG. 2 is a block diagram illustrating a construction of first and second HBM devices according to an embodiment of the present disclosure.

FIG. 3 is a block diagram illustrating a construction of first and second memory devices according to an embodiment of the present disclosure.

FIG. 4 is a diagram for describing operations of the first and second HBM devices according to an embodiment of the present disclosure.

FIG. 5 is a diagram for describing operations of the first and second HBM devices according to an embodiment of the present disclosure.

FIG. 6 is a diagram for describing operations of the first and second HBM devices according to an embodiment of the present disclosure.

FIG. 7 is a diagram for describing operations of the first and second HBM devices according to an embodiment of the present disclosure.

FIG. 8 is a diagram for describing operations of the first and second HBM devices according to an embodiment of the present disclosure.

### DETAILED DESCRIPTION

Terms, such as “first” and “second”, are used to distinguish between various elements and do not imply the size, order, priority, quantity, or importance of the elements. For example, a first element may be named a second element in one example, and a second element may be named a first element in another example.

When one component is identified as “connected” to another component, the components may be connected directly or through an intervening component between the components. When two components are identified as “directly connected,” one component is directly connected to the other component without an intervening component between the two components. The cross-hatching throughout the figures illustrates deactivated physical areas within the figures rather than indicating the materials for the physical areas.

Embodiments of the present disclosure are described with reference to the accompanying drawings. Specific structural or functional descriptions of embodiments are provided as examples to describe concepts that are disclosed in the present application. Examples or embodiments in accordance with the concepts may be carried out in various forms, and the scope of the present disclosure is not limited to the examples or embodiments described in this specification.

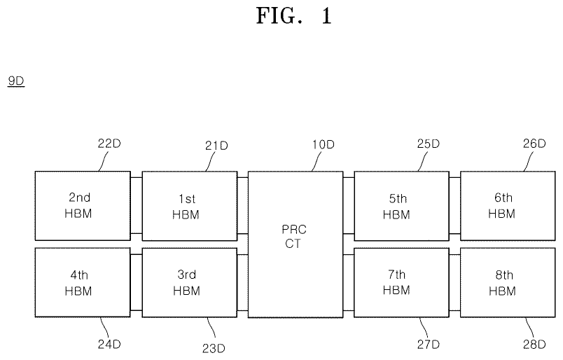

FIG. 1 is a block diagram illustrating a construction of a semiconductor system 9D according to an embodiment of the present disclosure. As illustrated in FIG. 1, the semiconductor system 9D may include a process circuit (PRC CT) 10D, a first HBM device (1^{st} HBM) 21D, a second HBM device (2^{nd} HBM) 22D, a third HBM device (3^{rd} HBM) 23D, a fourth HBM device (4^{th} HBM) 24D, a fifth HBM device (5^{th} HBM) 25D, a sixth HBM device (6^{th} HBM) 26D, a seventh HBM device (7^{th} HBM) 27D, and an eighth HBM device (8^{th} HBM) 28D.

The process circuit 10D may be electrically connected to the first HBM device 21D, the third HBM device 23D, the fifth HBM device 25D, and the seventh HBM device 27D. The process circuit 10D may control operations of the first HBM device 21D, the third HBM device 23D, the fifth HBM device 25D, and the seventh HBM device 27D. The process circuit 10D may perform an arithmetic operation by receiving data DATA from at least any one of the first HBM device 21D, the third HBM device 23D, the fifth HBM device 25D, and the seventh HBM device 27D.

The first HBM device 21D and the second HBM device 22D may be electrically connected. The third HBM device 23D and the fourth HBM device 24D may be electrically connected. The fifth HBM device 25D and the sixth HBM device 26D may be electrically connected. The seventh HBM device 27D and the eighth HBM device 28D may be electrically connected.

The first HBM device 21D and the second HBM device 22D may have physical areas included within the first HBM device 21D and the second HBM device 22D electrically connected, and may be connected to the process circuit 10D in common. The third HBM device 23D and the fourth HBM device 24D may have physical areas included within the third HBM device 23D and the fourth HBM device 24D electrically connected, and may be connected to the process circuit 10D in common. The fifth HBM device 25D and the sixth HBM device 26D may have physical areas included within the fifth HBM device 25D and the sixth HBM device 26D electrically connected, and may be connected to the process circuit 10D in common. The seventh HBM device 27D and the eighth HBM device 28D may have physical areas included within the seventh HBM device 27D and the eighth HBM device 28D electrically connected, and may be connected to the process circuit 10D in common.

The semiconductor system 9D illustrated in FIG. 1 is implemented so that two HBM devices are electrically connected to the process circuit 10D, but various numbers of HBM devices may be electrically connected to the process circuit 10D according to an embodiment.

The process circuit 10D may control operations of the first HBM device 21D and the second HBM device 22D that is electrically connected to the first HBM device 21D. The process circuit 10D may perform an arithmetic operation by receiving the data DATA from the first HBM device 21D and the second HBM device 22D. The process circuit 10D may control operations of the third HBM device 23D and the fourth HBM device 24D that is electrically connected to the third HBM device 23D. The process circuit 10D may perform an arithmetic operation by receiving the data DATA from the third HBM device 23D and the fourth HBM device 24D. The process circuit 10D may control operations of the fifth HBM device 25D and the sixth HBM device 26D that is electrically connected to the fifth HBM device 25D. The process circuit 10D may perform an arithmetic operation by receiving the data DATA from the fifth HBM device 25D and the sixth HBM device 26D. The process circuit 10D may control operations of the seventh HBM device 27D and the eighth HBM device 28D that is electrically connected to the seventh HBM device 27D. The process circuit 10D may perform an arithmetic operation by receiving the data DATA from the seventh HBM device 27D and the eighth HBM device 28D.

The process circuit 10D may be implemented with a graphics processing unit (GPU) and a neural processing unit (NPU).

The arithmetic operation may include a training operation and an inference operation. The training operation may be set as an operation of an artificial intelligence (AI) model learning a rule, a pattern, or a relation by optimizing weights and parameters from given data DATA. The inference operation may be set as an operation of an artificial intelligence (AI) model rapidly deriving results from new data by using weights learnt during the training operation.

The first HBM device 21D, the second HBM device 22D, the third HBM device 23D, the fourth HBM device 24D, the fifth HBM device 25D, the sixth HBM device 26D, the seventh HBM device 27D, and the eighth HBM device 23D may store data DATA within itself and output the data DATA stored within itself to other HBM devices. The first HBM device 21D, the second HBM device 22D, the third HBM device 23D, the fourth HBM device 24D, the fifth HBM device 25D, the sixth HBM device 26D, the seventh HBM device 27D, and the eighth HBM device 23D may be disposed at the boundary of a physical area D2D PHY. The first HBM device 21D, the second HBM device 22D, the third HBM device 23D, the fourth HBM device 24D, the fifth HBM device 25D, the sixth HBM device 26D, the seventh HBM device 27D, and the eighth HBM device 23D may be electrically connected to the process circuit 10D and different HBM devices through the physical area D2D PHY. The first HBM device 21D, the second HBM device 22D, the third HBM device 23D, the fourth HBM device 24D, the fifth HBM device 25D, the sixth HBM device 26D, the seventh HBM device 27D, and the eighth HBM device 23D may be shared by the process circuit 10D through the physical area D2D PHY.

The semiconductor system 9D according to an embodiment of the present disclosure can extend a data capacity that is used in an arithmetic operation because a plurality of HBM devices is electrically connected to different HBM devices and electrically connected to the process circuit. In an embodiment, the semiconductor system 9D can rapidly perform an arithmetic operation by increasing the number of HBM devices electrically connected to the process circuit and performing the arithmetic operation. In an embodiment, the semiconductor system 9D can variously set the bandwidth of data by selectively activating a plurality of physical layers (PHY) included in HBM devices. In an embodiment, the semiconductor system 9D can reduce current consumption by selectively activating a plurality of physical layers (PHY) included in HBM devices based on the bandwidth of data.

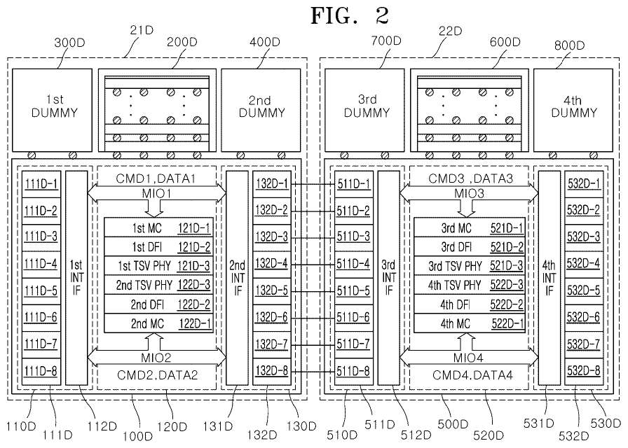

FIG. 2 is a block diagram illustrating a construction of the first HBM device 21D and the second HBM device 22D according to an embodiment of the present disclosure.

The first HBM device 21D may include a first control device 100D, a first memory device 200D, a first dummy die group (1^{st} DUMMY) 300D, and a second dummy die group (2^{nd} DUMMY) 400D.

The first control device 100D may generate a first command CMD1, first data DATA1, a second command CMD2, and second data DATA2. The first control device 100D may output the first command CMD1, the first data DATA1, the second command CMD2, and the second data DATA2 to the first memory device 200D. The first control device 100D may receive the first data DATA1 and the second data DATA2 from the first memory device 200D. The first control device 100D may be a base chip or a controller that controls an operation of the first memory device 200D.

The first control device 100D may include a first area 110D, a second area 120D, and a third area 130D. An upper part of the first area 110D may be set as a first predetermined area. An upper part of the second area 120D may be set as a second predetermined area. An upper part of the third area 130D may be set as a third predetermined area.

The first area 110D may be set as an area in which the first command CMD1, the first data DATA1, the second command CMD2, and the second data DATA2 are generated. The first area 110D may be set as an area in which the first command CMD1, the first data DATA1, the second command CMD2, and the second data DATA2 are input and output. When the first command CMD1, the first data DATA1, the second command CMD2, and the second data DATA2 are input to and output from the first area 110D, heat may be generated. The second area 120D may be set as an area in which the first command CMD1 and the first data DATA1 are received from the first area 110D and output to the first memory device 200D and the third area 130D and the first data DATA1 are received from the first memory device 200D and output to the first area 110D and the third area 130D. The second area 120D may be set as an area in which the second command CMD2 and the second data DATA2 are received from the first area 110D and output to the first memory device 200D and the third area 130D and the second data DATA2 are received from the first memory device 200D and output to the first area 110D and the third area 130D. The third area 130D may be set as an area in which the first command CMD1, the first data DATA1, the second command CMD2, and the second data DATA2 are received and the first command CMD1, the first data DATA1, the second command CMD2, and the second data DATA2 are input and output. The third area 130D may be set as an area in which the first command CMD1, the first data DATA1, the second command CMD2, and the second data DATA2 are input to and output from another HBM device, a process circuit, or an external device. When the first command CMD1, the first data DATA1, the second command CMD2, and the second data DATA2 are input to and output from the third area 130D, heat may be generated.

The first area 110D may include a first physical area 111D and a first internal interface area (1^{st} INT IF) 112D.

The first physical area 111D may include first to eighth physical layers 111D-1 to 111D-8. The first physical area 111D may generate the first command CMD1, the first data DATA1, the second command CMD2, and the second data DATA2 based on a signal input from the process circuit 10D through the first to eighth physical layers 111D-1 to 111D-8. As some of the first to eighth physical layers 111D-1 to 111D-8 are activated, the first physical area 111D may generate the first command CMD1, the first data DATA1, the second command CMD2, and the second data DATA2 based on a signal input from the process circuit 10D. At least two physical layers of the first to eighth physical layers 111D-1 to 111D-8 may be set as one group. For example, the first physical layer 111D-1, the second physical layer 111D-2, the third physical layer 111D-3 and the fourth physical layer 111D-4 may be set as a first group of physical layers. The fifth physical layer 111D-5, the sixth physical layer 111D-6, the seventh physical layer 111D-7, and the eighth physical layer 111D-8 may be set as a second group of physical layers. Furthermore, the first physical layer 111D-1, the third physical layer 111D-3, the fifth physical layer 111D-5, and the seventh physical layer 111D-7 may be set as a first group of physical layers. The second physical layer 111D-2, the fourth physical layer 111D-4, the sixth physical layer 111D-6, and the eighth physical layer 111D-8 may be set as a second group of physical layers. The first to eighth physical layers 111D-1 to 111D-8 may be a physical layer (PHY) that is responsible for the generation, transmission, reception, and physical connection of signals and data between an external device and the first control device 100D.

The first to eighth physical layers 111D-1 to 111D-8 may be selectively activated. The first to eighth physical layers 111D-1 to 111D-8 may be selectively activated under the control of the process circuit 10D. The first to eighth physical layers 111D-1 to 111D-8 may be selectively activated by the setting of a mode register set (MRS) included in the HBM device. The first to eighth physical layers 111D-1 to 111D-8 may be selectively activated by a device, such as IEEE1500 included in the HBM device. The first to eighth physical layers 111D-1 to 111D-8 may be selectively activated based on the bandwidth of data.

For example, the bandwidth of data when the first to fourth physical layers 111D-1 to 111D-4 are activated and the fifth to eighth physical layers 111D-5 to 111D-8 are deactivated may be set as a bandwidth that is ½ of the bandwidth of data when the first to eighth physical layers 111D-1 to 111D-8 are activated. The bandwidth of data when the first and second physical layers 111D-1 and 111D-2 are activated and the third to eighth physical layers 111D-3 to 111D-8 are deactivated may be set as a bandwidth that is ¼ of the bandwidth of data when the first to eighth physical layers 111D-1 to 111D-8 are activated.

The first physical area 111D may generate the first command CMD1, the first data DATA1, the second command CMD2, and the second data DATA2 based on a signal input from the process circuit 10D. The first physical area 111D may output the first command CMD1, the first data DATA1, the second command CMD2, and the second data DATA2 to the first internal interface area 112D. The first physical area 111D may receive the first data DATA1 and the second data DATA2 from the first internal interface area 112D and output the first data DATA1 and the second data DATA2 to the process circuit 10D.

The first internal interface area 112D may receive the first command CMD1, the first data DATA1, the second command CMD2, and the second data DATA2 from the first physical area 111D. The first internal interface area 112D may output the first command CMD1 and the first data DATA1 to a first internal input and output line MIO1 by adjusting the input and output sequence of the first command CMD1 and the first data DATA1. The first internal interface area 112D may output the second command CMD2 and the second data DATA2 to a second internal input and output line MIO2 by adjusting the input and output sequence of the second command CMD2 and the second data DATA2. The first internal interface area 112D may receive the first data DATA1 from the first internal input and output line MIO1 and output the first data DATA1 to the first physical area 111D. The first internal interface area 112D may receive the second data DATA2 from the second internal input and output line MIO2 and output the second data DATA2 to the first physical area 111D. The first internal interface area 112D may output the first command CMD1, the first data DATA1, the second command CMD2, and the second data DATA2 to the second area 120D and the third area 130D by adjusting the input and output sequence of the first command CMD1, the first data DATA1, the second command CMD2, and the second data DATA2. The first internal interface area 112D may be an interface that defines the timing and sequence of signals transmitted between the physical layer (PHY) and internal circuits and inputs and outputs the signals. The first internal interface area 112D and the first and second internal input and output lines MIO1 and MIO2 may be implemented as a network-on-chip (NoC). The network-on-chip (NoC) may be set as a transmission path that connects several internal circuits within a chip.

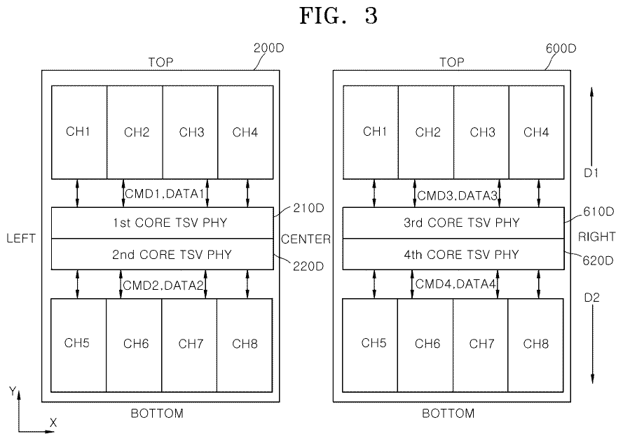

The second area 120D may include a first memory controller (1^{st} MC) 121D-1, a first base interface area (1^{st} DFI) 121D-2, a first base TSV area (1^{st} TSV PHY) 121D-3, a second memory controller (2^{nd} MC) 122D-1, a second base interface area (2^{nd} DFI) 122D-2, and a second base TSV area (2^{nd} TSV PHY) 122D-3 that control an operation of the first memory device 200D. The first memory controller 121D-1, the first base interface area 121D-2, and the first base TSV area 121D-3 may be components that control an operation of a first group of channels (CH1 to CH4 in FIG. 3) included in the first memory device 200D. The second memory controller 122D-1, the second base interface area 122D-2, and the second base TSV area 122D-3 may be components that control an operation of a second group of channels (CH5 to CH8 in FIG. 3) included in the first memory device 200D.

The first memory controller 121D-1, the first base interface area 121D-2, the first base TSV area 121D-3, the second memory controller 122D-1, the second base interface area 122D-2, and the second base TSV area 122D-3 may be disposed in the horizontal direction of the first control device 100D. The first memory controller 121D-1, the first base interface area 121D-2, and the first base TSV area 121D-3, and the second memory controller 122D-1, the second base interface area 122D-2, and the second base TSV area 122D-3 may be disposed at various locations of the second area 120D according to an embodiment.

The first memory controller 121D-1 may be electrically connected to the first internal input and output line MIO1. The first memory controller 121D-1 may receive the first command CMD1 and the first data DATA1 that control an operation of the first group of channels (CH1 to CH4 in FIG. 3) included in the first memory device 200D through the first internal input and output line MIO1. The first memory controller 121D-1 may output the first command CMD1 and the first data DATA1 that control an operation of the first group of channels (CH1 to CH4 in FIG. 3) included in the first memory device 200D. The first memory controller 121D-1 may receive the first data DATA1 from the first base interface area 121D-2 and output the first data DATA1 to the first internal input and output line MIO1.

The first base interface area 121D-2 may be electrically connected to the first memory controller 121D-1. The first base interface area 121D-2 may receive the first command CMD1 and the first data DATA1 from the first memory controller 121D-1. The first base interface area 121D-2 may output the first command CMD1 and the first data DATA1 to the first base TSV area 121D-3 by adjusting the input and output sequence of the first command CMD1 and the first data DATA1. The first base interface area 121D-2 may receive the first data DATA1 from the first base TSV area 121D-3 and output the first data DATA1 to the first memory controller 121D-1.

The first base TSV area 121D-3 may be electrically connected to the first base interface area 121D-2. The first base TSV area 121D-3 may receive the first command CMD1 and the first data DATA1 from the first base interface area 121D-2. The first base TSV area 121D-3 may output the first command CMD1 and the first data DATA1 to a first core TSV area (1^{st} CORE TSV PHY) (210D in FIG. 3) included in the first memory device 200D through a plurality of TSVs. The first base TSV area 121D-3 may receive the first data DATA1 from the first memory device 200D and output the first data DATA1 to the first base interface area 121D-2.

The second memory controller 122D-1 may be electrically connected to the second internal input and output line MIO2. The second memory controller 122D-1 may receive the second command CMD2 and the second data DATA2 that control an operation of the second group of channels (CH5 to CH8 in FIG. 3) included in the first memory device 200D through the second internal input and output line MIO2. The second memory controller 122D-1 may output the second command CMD2 and the second data DATA2 that control an operation of the second group of channels (CH5 to CH8 in FIG. 3) included in the first memory device 200D. The second memory controller 122D-1 may receive the second data DATA2 from the second base interface area 122D-2 and output the second data DATA2 to the second internal input and output line MIO2.

The second base interface area 122D-2 may be electrically connected to the second memory controller 122D-1. The second base interface area 122D-2 may receive the second command CMD2 and the second data DATA2 from the second memory controller 122D-1. The second base interface area 122D-2 may output the second command CMD2 and the second data DATA2 to the second base TSV area 122D-3 by adjusting the input and output sequence of the second command CMD2 and the second data DATA2. The second base interface area 122D-2 may receive the second data DATA2 from the second base TSV area 122D-3 and output the second data DATA2 to the second memory controller 122D-1.

The second base TSV area 122D-3 may be electrically connected to the second base interface area 122D-2. The second base TSV area 122D-3 may receive the second command CMD2 and the second data DATA2 from the second base interface area 122D-2. The second base TSV area 122D-3 may output the second command CMD2 and the second data DATA2 to a second core TSV area (2^{nd} CORE TSV PHY) (220D in FIG. 3) included in the first memory device 200D through a plurality of TSVs. The second base TSV area 122D-3 may receive the second data DATA2 from the first memory device 200D and output the second data DATA2 to the second base interface area 122D-2.

The third area 130D may include a second internal interface area (2^{nd} INT IF) 131D and a second physical area 132D.

The second internal interface area 131D may receive the first command CMD1 and the first data DATA1 from the first internal input and output line MIO1. The second internal interface area 131D may receive the second command CMD2 and the second data DATA2 from the second internal input and output line MIO2. The second internal interface area 131D may output the first command CMD1, the first data DATA1, the second command CMD2, and the second data DATA2 to the second physical area 132D by adjusting the input and output sequence of the first command CMD1, the first data DATA1, the second command CMD2, and the second data DATA2. The second internal interface area 131D may receive the first data DATA1 from the second physical area 132D and output the first data DATA1 to the first internal interface area 112D through the first internal input and output line MIO1. The second internal interface area 131D may receive the second data DATA2 from the second physical area 132D and output the second data DATA2 to the first internal interface area 112D through the second internal input and output line MIO2. The second internal interface area 131D may be an interface that defines the timing and sequence of signals transmitted between the physical layer (PHY) and internal circuits and inputs and outputs the signals. The second internal interface area 131D may be implemented as a network-on-chip (NoC).

The second physical area 132D may include ninth to sixteenth physical layers 132D-1 to 132D-8. The second physical area 132D may receive the first command CMD1, the first data DATA1, the second command CMD2, and the second data DATA2 from the second internal interface area 131D through the ninth to sixteenth physical layers 132D-1 to 132D-8. The second physical area 132D may output the first command CMD1, the first data DATA1, the second command CMD2, and the second data DATA2 to the second HBM device 22D and the process circuit 10D. The second physical area 132D may receive the third data DATA3 and the fourth data DATA4 from the second HBM device 22D. At least two physical layers, among the ninth to sixteenth physical layers 132D-1 to 132D-8, may be set as one group. For example, the ninth physical layer 132D-1, the tenth physical layer 132D-2, the eleventh physical layer 132D-3, and the twelfth physical layer 132D-4 may be set as a first group of physical layers. The thirteenth physical layer 132D-5, the fourteenth physical layer 132D-6, the fifteenth physical layer 132D-7, and the sixteenth physical layer 132D-8 may be set as a second group of physical layers. Furthermore, the ninth physical layer 132D-1, the eleventh physical layer 132D-3, the thirteenth physical layer 132D-5, and the fifteenth physical layer 132D-7 may be set as a first group of physical layers. The tenth physical layer 132D-2, the twelfth physical layer 132D-4, the fourteenth physical layer 132D-6, and the sixteenth physical layer 132D-8 may be set as a second group of physical layers. The ninth to sixteenth physical layers 132D-1 to 132D-8 may be a physical layer (PHY), respectively, that is responsible for the generation, transmission, reception, and physical connection of signals and data between an external device, the first control device 100D, and another HBM device.

The ninth to sixteenth physical layers 132D-1 to 132D-8 may be selectively activated. The ninth to sixteenth physical layers 132D-1 to 132D-8 may be selectively activated under the control of the process circuit 10D. The ninth to sixteenth physical layers 132D-1 to 132D-8 may be selectively activated by the setting of a mode register set (MRS) included in the HBM device. The ninth to sixteenth physical layers 132D-1 to 132D-8 may be selectively activated by a device, such as IEEE1500 included in the HBM device. The ninth to sixteenth physical layers 132D-1 to 132D-8 may be selectively activated based on the bandwidth of data.

For example, the bandwidth of data when the ninth to twelfth physical layers 132D-1 to 132D-4 are activated and the thirteenth to sixteenth physical layers 132D-5 to 132D-8 are deactivated may be set as a bandwidth that is ½ of the bandwidth of data when the ninth to sixteenth physical layers 132D-1 to 132D-8 are activated. The bandwidth of data when the ninth and tenth physical layers 132D-1 and 132D-2 are activated and the eleventh to sixteenth physical layers 132D-3 to 132D-8 are deactivated may be set as a bandwidth that is ¼ of the bandwidth of data when the ninth to sixteenth physical layers 132D-1 to 132D-8 are activated.

The second physical area 132D may output the first command CMD1, the first data DATA1, the second command CMD2, and the second data DATA2 that are input from the second internal interface area 131D, to the second HBM device 22D. The second physical area 132D may generate the first data DATA1 and the second data DATA2 by receiving the third data DATA3 and the fourth data DATA4 from the second HBM device 22D. The second physical area 132D may output the first data DATA1 and the second data DATA2 to the second internal interface area 131D.

The third area 130D of the first control device 100D may be electrically connected to the fourth area 510D of a second control device 500D. The ninth to sixteenth physical layers 132D-1 to 132D-8 included in the third area 130D may be electrically connected to seventeenth to twenty-fourth physical layers 511D-1 to 511D-8 included in the fourth area 510D, respectively. When, for example, all of the physical layers (e.g., ninth to sixteenth physical layers 132D-1 to 132D-8) included in the third area 130D are deactivated, the connection of the first HBM device 21D to the second HBM device 22D is disconnected. When the connection of the first HBM device 21D to the second HBM device 22D is disconnected the bandwidth of data between the first and second HBM devices 21D and 22D is zero. In this way, in an embodiment, the semiconductor system 9D can reduce current consumption by selectively activating a plurality of physical layers (PHY) included in HBM devices based on the bandwidth of data.

The first memory device 200D may be vertically stacked on the second area 120D of the first control device 100D. The first memory device 200D may be disposed in the second predetermined area. The first memory device 200D may include a plurality of core dies that is vertically stacked. The first memory device 200D may receive the first command CMD1 and the first data DATA1 from the first base TSV area 121D-3. The first memory device 200D may perform an internal operation based on the first command CMD1 and the first data DATA1. The first memory device 200D may store the first data DATA1 in the plurality of core dies after the start of a write operation based on the first command CMD1. The first memory device 200D may output the first data DATA1 stored in the plurality of core dies to the first base TSV area 121D-3 after the start of a read operation based on the first command CMD1. The first memory device 200D may receive the second command CMD2 and the second data DATA2 from the second base TSV area 122D-3. The first memory device 200D may perform an internal operation based on the second command CMD2 and the second data DATA2. The first memory device 200D may store the second data DATA1 in the plurality of core dies after the start of a write operation based on the second command CMD2. The first memory device 200D may output the second data DATA2 in the plurality of core dies to the second base TSV area 122D-3 after the start of a read operation based on the second command CMD2.

The first dummy die group 300D may be vertically stacked on the first area 110D of the first control device 100D. The first dummy die group 300D may be disposed in the first predetermined area. The first dummy die group 300D may be implemented by stacking a plurality of dummy dies (not illustrated). The first dummy die group 300D may have the same height as the first memory device 200D. The plurality of dummy dies (not illustrated) included in the first dummy die group 300D may have the same height as the plurality of core dies (not illustrated) included in the first memory device 200D. The first dummy die group 300D may be one dummy die according to an embodiment. The first predetermined area in which the first dummy die group 300D is formed may be an empty space according to an embodiment. The first dummy die group 300D can discharge heat generated from the first area 110D of the first control device 100D. The plurality of dummy dies (not illustrated) included in the first dummy die group 300D may be connected through a plurality of TSVs and a plurality of micro bump pads so that heat can be easily discharged.

The second dummy die group 400D may be vertically stacked on the third area 130D of the first control device 100D. The second dummy die group 400D may be disposed in the third predetermined area. The second dummy die group 400D may be implemented by stacking a plurality of dummy dies (not illustrated). The second dummy die group 400D may have the same height as the first memory device 200D. The plurality of dummy dies (not illustrated) included in the second dummy die group 400D may have the same height as the plurality of core dies (not illustrated) included in the first memory device 200D. The second dummy die group 400D may be one dummy die according to an embodiment. The third predetermined area in which the second dummy die group 400D is formed may be an empty space according to an embodiment. The second dummy die group 400D can discharge heat generated from the third area 130D of the first control device 100D. The plurality of dummy dies (not illustrated) included in the second dummy die group 400D may be connected through a plurality of TSVs and a plurality of micro bump pads so that heat can be easily discharged.

The second HBM device 22D may include the second control device 500D, a second memory device 600D, a third dummy die group (3^{rd} DUMMY) 700D, and a fourth dummy die group (4^{th} DUMMY) 800D.

The second control device 500D may generate a third command CMD3, third data DATA3, a fourth command CMD4, and fourth data DATA4. The second control device 500D may output the third command CMD3, the third data DATA3, the fourth command CMD4, and the fourth data DATA4 to the second memory device 600D. The second control device 500D may receive the third data DATA3 and the fourth data DATA4 from the second memory device 600D. The second control device 500D may be a base chip or a controller that controls an operation of the second memory device 600D.

The second control device 500D may include the fourth area 510D, a fifth area 520D, and a sixth area 530D. An upper part of the fourth area 510D may be set as a fourth predetermined area. An upper part of the fifth area 520D may be set as a fifth predetermined area. An upper part of the sixth area 530D may be set as a sixth predetermined area.

The fourth area 510D may be set as an area in which the third command CMD3, the third data DATA3, the fourth command CMD4, and the fourth data DATA4 are generated. The fourth area 510D may be set as an area in which the third command CMD3, the third data DATA3, the fourth command CMD4, and the fourth data DATA4 are input and output. When the third command CMD3, the third data DATA3, the fourth command CMD4, and the fourth data DATA4 are input to and output from the fourth area 510D, heat may be generated. The fifth area 520D may be set as an area in which the third command CMD3 and the third data DATA3 are received from the fourth area 510D and output to the second memory device 600D and the sixth area 530D and the third data DATA3 are received from the second memory device 600D and output to the fourth area 510D and the sixth area 530D. The fifth area 520D may be set as an area in which the fourth command CMD4 and the fourth data DATA4 are received from the fourth area 510D and output to the second memory device 600D and the sixth area 530D and the fourth data DATA4 are received from the second memory device 600D and output to the fourth area 510D and the sixth area 530D. The sixth area 530D may be set as an area in which the third command CMD3, the third data DATA3, the fourth command CMD4, and the fourth data DATA4 are received and the third command CMD3, the third data DATA3, the fourth command CMD4, and the fourth data DATA4 are input and output. The sixth area 530D may be set as an area in which the third command CMD3, the third data DATA3, the fourth command CMD4, and the fourth data DATA4 are input to and output from another HBM device, a process circuit, or an external device. When the third command CMD3, the third data DATA3, the fourth command CMD4, and the fourth data DATA4 are input to and output from the sixth area 530D, heat may be generated.

The fourth area 510D may include a third physical area 511D and a third internal interface area (3^{rd} INT IF) 512D.

The third physical area 511D may include the seventeenth to twenty-fourth physical layers 511D-1 to 511D-8. The third physical area 511D may generate the third command CMD3, the third data DATA3, the fourth command CMD4, and the fourth data DATA4 based on the first command CMD1, the first data DATA1, the second command CMD2, and the second data DATA2 that are input from the first HBM device 21D through the seventeenth to twenty-fourth physical layers 511D-1 to 511D-8. The third physical area 511D may generate the third command CMD3, the third data DATA3, the fourth command CMD4, and the fourth data DATA4 based on the first command CMD1, the first data DATA1, the second command CMD2, and the second data DATA2 that are input from the first HBM device 21D as some of the seventeenth to twenty-fourth physical layers 511D-1 to 511D-8 are activated. At least two physical layers, among the seventeenth to twenty-fourth physical layers 511D-1 to 511D-8, may be set as one group. For example, the seventeenth physical layer 511D-1, the eighteenth physical layer 511D-2, the nineteenth physical layer 511D-3, and the twentieth physical layer 511D-4 may be set as a first group of physical layers. The twenty-first physical layer 511D-5, the twenty-second physical layer 511D-6, the twenty-third physical layer 511D-7, and the twenty-fourth physical layer 511D-8 may be set as a second group of physical layers. Furthermore, the seventeenth physical layer 511D-1, the nineteenth physical layer 511D-3, the twenty-first physical layer 511D-5, and the twenty-third physical layer 511D-7 may be set as a first group of physical layers. The eighteenth physical layer 511D-2, the twentieth physical layer 511D-4, the twenty-second physical layer 511D-6, and the twenty-fourth physical layer 511D-8 may be set as a second group of physical layers. The seventeenth to twenty-fourth physical layers 511D-1 to 511D-8 may be a physical layer (PHY), respectively, that is responsible for the generation, transmission, reception, and physical connection of signals and data between the first control device 100D of the first HBM device 21D and the second control device 500D of the second HBM device 22D.

The seventeenth to twenty-fourth physical layers 511D-1 to 511D-8 may be selectively activated. The seventeenth to twenty-fourth physical layers 511D-1 to 511D-8 may be selectively activated under the control of the process circuit 10D. The seventeenth to twenty-fourth physical layers 511D-1 to 511D-8 may be selectively activated by the setting of a mode register set (MRS) included in the HBM device. The seventeenth to twenty-fourth physical layers 511D-1 to 511D-8 may be selectively activated by a device, such as IEEE1500 included in the HBM device. The seventeenth to twenty-fourth physical layers 511D-1 to 511D-8 may be selectively activated based on the bandwidth of data.

For example, the bandwidth of data when the seventeenth to twentieth physical layers 511D-1 to 511D-4 are activated and the twenty-first to twenty-fourth physical layers 511D-5 to 511D-8 are deactivated may be set as a bandwidth that is ½ of the bandwidth of data when the seventeenth to twenty-fourth physical layers 511D-1 to 511D-8 are activated. The bandwidth of data when the seventeenth and eighteenth physical layers 511D-1 and 511D-2 are activated and the nineteenth to twenty-fourth physical layers 511D-3 to 511D-8 are deactivated may be set as a bandwidth that is ¼ of the bandwidth of data when the seventeenth to twenty-fourth physical layers 511D-1 to 511D-8 are activated.

The third physical area 511D may generate the third command CMD3, the third data DATA3, the fourth command CMD4, and the fourth data DATA4 based on the first command CMD1, the first data DATA1, the second command CMD2, and the second data DATA2 that are input from the first HBM device 21D. The third physical area 511D may output the third command CMD3, the third data DATA3, the fourth command CMD4, and the fourth data DATA4 to the third internal interface area 512D. The third physical area 511D may receive the third data DATA3 and the fourth data DATA4 from the third internal interface area 512D and output the third data DATA3 and the fourth data DATA4 to the first HBM device 21D.

The fourth area 510D of the second control device 500D may be electrically connected to the third area 130D of the first control device 100D. The seventeenth to twenty-fourth physical layers 511D-1 to 511D-8 included in the fourth area 510D may be electrically connected to the ninth to sixteenth physical layers 132D-1 to 132D-8 included in the third area 130D, respectively.

The third internal interface area 512D may receive the third command CMD3, the third data DATA3, the fourth command CMD4, and the fourth data DATA4 from the third physical area 511D. The third internal interface area 512D may output the third command CMD3 and the third data DATA3 to a third internal input and output line MIO3 by adjusting the input and output sequence of the third command CMD3 and the third data DATA3. The third internal interface area 512D may output the fourth command CMD4 and the fourth data DATA4 to a fourth internal input and output line MIO4 by adjusting the input and output sequence of the fourth command CMD4 and the fourth data DATA4. The third internal interface area 512D may receive the third data DATA3 from the third internal input and output line MIO3 and output the third data DATA3 to the third physical area 511D. The third internal interface area 512D may receive the fourth data DATA4 from the fourth internal input and output line MIO4 and output the fourth data DATA4 to the third physical area 511D. The third internal interface area 512D may output the third command CMD3, the third data DATA3, the fourth command CMD4, and the fourth data DATA4 to the fifth area 520D and the sixth area 530D by adjusting the input and output sequence of the third command CMD3, the third data DATA3, the fourth command CMD4, and the fourth data DATA4. The third internal interface area 512D may be an interface that defines the timing and sequence of signals transmitted between the physical layer (PHY) and internal circuits and inputs and outputs the signals. The third internal interface area 512D and the third and fourth internal input and output lines MIO3 and MIO4 may be implemented as a network-on-chip (NoC). The network-on-chip (NoC) may be set as a transmission path that connects several internal circuits within a chip.

The fifth area 520D may include a third memory controller (3^{rd} MC) 521D-1, a third base interface area (3^{rd} DFI) 521D-2, a third base TSV area (3^{rd} TSV PHY) 521D-3, a fourth memory controller (4^{th} MC) 522D-1, a fourth base interface area (4^{th} DFI) 522D-2, and a fourth base TSV area (4^{th} TSV PHY) 522D-3 that control an operation of the second memory device 600D. The third memory controller 521D-1, the third base interface area 521D-2, and the third base TSV area 521D-3 may be components that control an operation of a first group of channels (CH1 to CH4 in FIG. 3) included in the second memory device 600D. The fourth memory controller 522D-1, the fourth base interface area 522D-2, and the fourth base TSV area 522D-3 may be components that control an operation of a second group of channels (CH5 to CH8 in FIG. 3) included in the second memory device 600D.

The third memory controller 521D-1, the third base interface area 521D-2, the third base TSV area 521D-3, the fourth memory controller 522D-1, the fourth base interface area 522D-2, and the fourth base TSV area 522D-3 may be disposed in the horizontal direction of the second control device 500D. The third memory controller 521D-1, the third base interface area 521D-2, and the third base TSV area 521D-3, and the fourth memory controller 522D-1, the fourth base interface area 522D-2, and the fourth base TSV area 522D-3 may be disposed at various locations of the fifth area 520D according to an embodiment.

The third memory controller 521D-1 may be electrically connected to the third internal input and output line MIO3. The third memory controller 521D-1 may receive the third command CMD3 and the third data DATA3 that control an operation of the first group of channels (CH1 to CH4 in FIG. 3) included in the second memory device 600D through the third internal input and output line MIO3. The third memory controller 521D-1 may output the third command CMD3 and the third data DATA3 that control an operation of the first group of channels (CH1 to CH4 in FIG. 3) included in the second memory device 600D. The third memory controller 521D-1 may receive the third data DATA3 from the third base interface area 521D-2 and output the third data DATA3 to the third internal input and output line MIO3.

The third base interface area 521D-2 may be electrically connected to the third memory controller 521D-1. The third base interface area 521D-2 may receive the third command CMD3 and the third data DATA3 from the third memory controller 521D-1. The third base interface area 521D-2 may output the third command CMD3 and the third data DATA3 to the third base TSV area 521D-3 by adjusting the input and output sequence of the third command CMD3 and the third data DATA3. The third base interface area 521D-2 may receive the third data DATA3 from the third base TSV area 521D-3 and output the third data DATA3 to the third memory controller 521D-1.

The third base TSV area 521D-3 may be electrically connected to the third base interface area 521D-2. The third base TSV area 521D-3 may receive the third command CMD3 and the third data DATA3 from the third base interface area 521D-2. The third base TSV area 521D-3 may output the third command CMD3 and the third data DATA3 to a third core TSV area (3^{rd} CORE TSV PHY) (610D in FIG. 3) included in the second memory device 600D through a plurality of TSVs. The third base TSV area 521D-3 may receive the third data DATA3 from the second memory device 600D and output the third data DATA3 to the third base interface area 521D-2.

The fourth memory controller 522D-1 may be electrically connected to the fourth internal input and output line MIO4. The fourth memory controller 522D-1 may receive the fourth command CMD4 and the fourth data DATA4 that control an operation of a second group of channels (CH5 to CH8 in FIG. 3) included in the second memory device 600D through the fourth internal input and output line MIO4. The fourth memory controller 522D-1 may output the fourth command CMD4 and the fourth data DATA4 that control an operation of the second group of channels (CH5 to CH8 in FIG. 3) included in the second memory device 600D. The fourth memory controller 522D-1 may receive the fourth data DATA4 from the fourth base interface area 522D-2 and output the fourth data DATA4 to the fourth internal input and output line MIO4.

The fourth base interface area 522D-2 may be electrically connected to the fourth memory controller 522D-1. The fourth base interface area 522D-2 may receive the fourth command CMD4 and the fourth data DATA4 from the fourth memory controller 522D-1. The fourth base interface area 522D-2 may output the fourth command CMD4 and the fourth data DATA4 to the fourth base TSV area 522D-3 by adjusting the input and output sequence of the fourth command CMD4 and the fourth data DATA4. The fourth base interface area 522D-2 may receive the fourth data DATA4 from the fourth base TSV area 522D-3 and output the fourth data DATA4 to the fourth memory controller 522D-1.

The fourth base TSV area 522D-3 may be electrically connected to the fourth base interface area 522D-2. The fourth base TSV area 522D-3 may receive the fourth command CMD4 and the fourth data DATA4 from the fourth base interface area 522D-2. The fourth base TSV area 522D-3 may output the fourth command CMD4 and the fourth data DATA4 to a fourth core TSV area (4^{th} CORE TSV PHY) (620D in FIG. 3) included in the second memory device 600D through a plurality of TSVs. The fourth base TSV area 522D-3 may receive the second data DATA2 from the second memory device 600D and output the second data DATA2 to the fourth base interface area 522D-2.

The sixth area 530D may include a fourth internal interface area (4^{th} INT IF) 531D and a fourth physical area 532D.

The fourth internal interface area 531D may receive the third command CMD3 and the third data DATA3 from the third internal input and output line MIO3. The fourth internal interface area 531D may receive the fourth command CMD4 and the fourth data DATA4 from the fourth internal input and output line MIO4. The fourth internal interface area 531D may output the third command CMD3, the third data DATA3, the fourth command CMD4, and the fourth data DATA4 to the fourth physical area 532D by adjusting the input and output sequence of the third command CMD3, the third data DATA3, the fourth command CMD4, and the fourth data DATA4. The fourth internal interface area 531D may receive the third data DATA3 from the fourth physical area 532D and output the third data DATA3 to the third internal interface area 512D through the third internal input and output line MIO3. The fourth internal interface area 531D may receive the fourth data DATA4 from the fourth physical area 532D and output the fourth data DATA4 to the third internal interface area 512D through the fourth internal input and output line MIO4. The fourth internal interface area 531D may be an interface that defines the timing and sequence of signals transmitted between the physical layer (PHY) and internal circuits and inputs and outputs the signals. The fourth internal interface area 531D may be implemented as a network-on-chip (NoC).

The fourth physical area 532D may include twenty-fifth to thirty-second physical layers 532D-1 to 532D-8. The fourth physical area 532D may receive the third command CMD3, the third data DATA3, the fourth command CMD4, and the fourth data DATA4 from the fourth internal interface area 531D through the twenty-fifth to thirty-second physical layers 532D-1 to 532D-8. The fourth physical area 532D may output the third command CMD3, the third data DATA3, the fourth command CMD4, and the fourth data DATA4 to an external device. The fourth physical area 532D may receive data from the external device. At least two physical layers, among the twenty-fifth to thirty-second physical layers 532D-1 to 532D-8, may be set as one group. For example, the twenty-fifth physical layer 532D-1, the twenty-sixth physical layer 532D-2, the twenty-seventh physical layer 532D-3, and the twenty-eighth physical layer 532D-4 may be set as a first group of physical layers. The twenty-ninth physical layer 532D-5, the thirtieth physical layer 532D-6, the thirty-first physical layer 532D-7, and the thirty-second physical layer 532D-8 may be set as a second group of physical layers. Furthermore, the twenty-fifth physical layer 532D-1, the twenty-seventh physical layer 532D-3, the twenty-ninth physical layer 532D-5, and the thirty-first physical layer 532D-7 may be set as a first group of physical layers. The twenty-sixth physical layer 532D-2, the twenty-eighth physical layer 532D-4, the thirtieth physical layer 532D-6, and the thirty-second physical layer 532D-8 may be set as a second group of physical layers. The twenty-fifth to thirty-second physical layers 532D-1 to 532D-8 may be a physical layer (PHY), respectively, that is responsible for the generation, transmission, reception, and physical connection of signals and data between an external device, the first control device 100D, and another HBM device.

The twenty-fifth to thirty-second physical layers 532D-1 to 532D-8 may be selectively activated. The twenty-fifth to thirty-second physical layers 532D-1 to 532D-8 may be selectively activated under the control of the process circuit 10D. The twenty-fifth to thirty-second physical layers 532D-1 to 532D-8 may be selectively activated by the setting of a mode register set (MRS) included in the HBM device. The twenty-fifth to thirty-second physical layers 532D-1 to 532D-8 may be selectively activated by a device, such as IEEE1500 included in the HBM device. The twenty-fifth to thirty-second physical layers 532D-1 to 532D-8 may be selectively activated based on the bandwidth of data.

For example, the bandwidth of data when the twenty-fifth to twenty-eighth physical layers 532D-1 to 532D-4 are activated and the twenty-ninth to thirty-second physical layers 532D-5 to 532D-8 are deactivated may be set as a bandwidth that is ½ of the bandwidth of data when the twenty-fifth to thirty-second physical layers 532D-1 to 532D-8 are activated. The bandwidth of data when the twenty-fifth and twenty-sixth physical layers 532D-1 and 532D-2 are activated and the twenty-seventh to thirty-second physical layers 532D-3 to 532D-8 are deactivated may be set as a bandwidth that is ¼ of the bandwidth of data when the twenty-fifth to thirty-second physical layers 532D-1 to 532D-8 are activated.

The fourth physical area 532D may output the third command CMD3, the third data DATA3, the fourth command CMD4, and the fourth data DATA4 that are input from the fourth internal interface area 531D, to an external device or still another HBM device. The fourth physical area 532D may generate the third data DATA3 and the fourth data DATA4 by receiving fifth data and sixth data from an external device or still another HBM device. The fourth physical area 532D may output the third data DATA3 and the fourth data DATA4 to the fourth internal interface area 531D.

The second memory device 600D may be vertically stacked on the fifth area 520D of the second control device 500D. The second memory device 600D may be disposed in the fifth predetermined area. The second memory device 600D may include a plurality of core dies that is vertically stacked. The second memory device 600D may receive the third command CMD3 and the third data DATA3 from the third base TSV area 521D-3. The second memory device 600D may perform an internal operation based on the third command CMD3 and the third data DATA3. The second memory device 600D may store the third data DATA3 in the plurality of core dies after the start of a write operation based on the third command CMD3. The second memory device 600D may output the third data DATA3 stored in the plurality of core dies to the third base TSV area 521D-3 after the start of a read operation based on the third command CMD3. The second memory device 600D may receive the fourth command CMD4 and the fourth data DATA4 from the fourth base TSV area 522D-3. The second memory device 600D may perform an internal operation based on the fourth command CMD4 and the fourth data DATA4. The second memory device 600D may store the fourth data DATA4 in the plurality of core dies after the start of a write operation based on the fourth command CMD4. The second memory device 600D may output the fourth data DATA4 stored in the plurality of core dies to the fourth base TSV area 522D-3 after the start of a read operation based on the fourth command CMD4.

The third dummy die group 700D may be vertically stacked on the fourth area 510D of the second control device 500D. The third dummy die group 700D may be disposed in the fourth predetermined area. The third dummy die group 700D may be implemented by stacking a plurality of dummy dies (not illustrated). The third dummy die group 700D may have the same height as the second memory device 600D. The plurality of dummy dies (not illustrated) included in the third dummy die group 700D may have the same height as the plurality of core dies (not illustrated) included in the second memory device 600D. The third dummy die group 700D may be one dummy die according to an embodiment. The fourth predetermined area in which the third dummy die group 700D is formed may be an empty space according to an embodiment. The third dummy die group 700D can discharge heat generated from the fourth area 510D of the second control device 500D. The plurality of dummy dies (not illustrated) included in the third dummy die group 700D may be connected through a plurality of TSVs and a plurality of micro bump pads so that heat can be easily discharged.

The fourth dummy die group 800D may be vertically stacked on the sixth area 530D of the second control device 500D. The fourth dummy die group 800D may be disposed in the sixth predetermined area. The fourth dummy die group 800D may be implemented by stacking a plurality of dummy dies (not illustrated). The fourth dummy die group 800D may have the same height as the second memory device 600D. The plurality of dummy dies (not illustrated) included in the fourth dummy die group 800D may have the same height as the plurality of core dies (not illustrated) included in the second memory device 600D. The fourth dummy die group 800D may be one dummy die according to an embodiment. The sixth predetermined area in which the fourth dummy die group 800D is formed may be an empty space according to an embodiment. The fourth dummy die group 800D can discharge heat generated from the sixth area 530D of the second control device 500D. The plurality of dummy dies (not illustrated) included in the fourth dummy die group 800D may be connected through a plurality of TSVs and a plurality of micro bump pads so that heat can be easily discharged.

As described above, the semiconductor system 9D according to an embodiment of the present disclosure can extend a data capacity that is used in an arithmetic operation because a plurality of HBM devices is electrically connected to different HBM devices and a plurality of HBM devices is electrically connected to the process circuit. In an embodiment, the semiconductor system 9D can rapidly perform an arithmetic operation by increasing the number of HBM devices electrically connected to the process circuit and performing the arithmetic operation. In an embodiment, the semiconductor system 9D can variously set the bandwidth of data by selectively activating a plurality of physical layers (PHY) included in HBM devices. In an embodiment, the semiconductor system 9D can reduce current consumption by selectively activating a plurality of physical layers (PHY) included in HBM devices based on the bandwidth of data.

FIG. 3 is a block diagram illustrating a construction of the first memory device 200D and the second memory device 600D according to an embodiment of the present disclosure.

The first memory device 200D may include the first to eighth channels CH1 to CH8, the first core TSV area 210D, and the second core TSV area 220D.

The first to eighth channels CH1 to CH8 may receive the first command CMD1, the first data DATA1, the second command CMD2, and the second data DATA2 by independently performing internal operations. The first to eighth channels CH1 to CH8 may store the first data DATA1 and the second data DATA2 after the start of a write operation of an internal operation based on the first command CMD1 and the second command CMD2. The first to eighth channels CH1 to CH8 may output the first data DATA1 and the second data DATA2 after the start of a read operation of an internal operation based on the first command CMD1 and the second command CMD2.

The first to fourth channels CH1 to CH4 may be electrically connected to the first core TSV area 210D. The first to fourth channels CH1 to CH4 may receive the first command CMD1 and the first data DATA1 from the first core TSV area 210D. The first to fourth channels CH1 to CH4 may output the first data DATA1 to the first core TSV area 210D. The first to fourth channels CH1 to CH4 may store, respectively, the first data DATA1 after the start of a write operation of an internal operation based on the first command CMD1. The first to fourth channels CH1 to CH4 may output, respectively, the first data DATA1 after the start of a read operation of an internal operation based on the first command CMD1. The first to fourth channels CH1 to CH4 may be set as a first group of channels.

The fifth to eighth CH5 to CH8 may be electrically connected to the second core TSV area 220D. The fifth to eighth CH5 to CH8 may receive, respectively, the second command CMD2 and the second data DATA2 from the second core TSV area 220D. The fifth to eighth CH5 to CH8 may output the second data DATA2 to the second core TSV area 220D. The fifth to eighth CH5 to CH8 may store, respectively, the second data DATA2 after the start of a write operation of an internal operation based on the second command CMD2. The fifth to eighth CH5 to CH8 may output, respectively, the second data DATA2 after the start of a read operation of an internal operation based on the second command CMD2. The fifth to eighth CH5 to CH8 may be set as a second group of channels.

The first to fourth channels CH1 to CH4 may be disposed in a first edge area TOP of the first memory device 200D. The fifth to eighth CH5 to CH8 may be disposed in a second edge area BOTTOM of the first memory device 200D. The first edge area TOP may be disposed in a first direction D1 from a central area CENTER of the first memory device 200D. The second edge area BOTTOM may be disposed in a second direction D2 from the central area CENTER of the first memory device 200D. The first edge area TOP may be set as an upper area of the first memory device 200D in a Y axis. The second edge area BOTTOM may be set as a lower area of the first memory device 200D in the Y axis.

The first core TSV area 210D may be electrically connected to the first base TSV area 121D-3 of the first control device 100D. The first core TSV area 210D may receive the first command CMD1 and the first data DATA1 from the first base TSV area 121D-3. The first core TSV area 210D may receive the first command CMD1 and the first data DATA1 through a plurality of TSVs. The first core TSV area 210D may output the first command CMD1 and the first data DATA1 to the first to fourth channels CH1 to CH4. The first core TSV area 210D may receive the first data DATA1 from the first to fourth channels CH1 to CH4 and output the first data DATA1 to the first base TSV area 121D-3. The first core TSV area 210D may be disposed in the central area CENTER.

The second core TSV area 220D may be electrically connected to the second base TSV area 122D-3 of the first control device 100D. The second core TSV area 220D may receive the second command CMD2 and the second data DATA2 from the second base TSV area 122D-3. The second core TSV area 220D may receive the second command CMD2 and the second data DATA2 through a plurality of TSVs. The second core TSV area 220D may output the second command CMD2 and the second data DATA2 to the fifth to eighth CH5 to CH8. The second core TSV area 220D may receive the second data DATA2 from the fifth to eighth CH5 to CH8 and output the second data DATA2 to the second base TSV area 122D-3. The second core TSV area 220D may be disposed in the central area CENTER.

The first to eighth channels CH1 to CH8, the first core TSV area 210D, and the second core TSV area 220D included in the first memory device 200D may be disposed at various locations according to an embodiment.

The first memory device 200D may be disposed in a left area LEFT in an X axis.

The second memory device 600D may include the first to eighth channels CH1 to CH8, the third core TSV area 610D, and the fourth core TSV area 620D.

The first to eighth channels CH1 to CH8 may receive the third command CMD3, the third data DATA3, the fourth command CMD4, and the fourth data DATA4 by independently performing internal operations. The first to eighth channels CH1 to CH8 may store, respectively, the third data DATA3 and the fourth data DATA4 after the start of a write operation of an internal operation based on the third command CMD3 and the fourth command CMD4. The first to eighth channels CH1 to CH8 may output, respectively, the third data DATA3 and the fourth data DATA4 after the start of a read operation of an internal operation based on the third command CMD3 and the fourth command CMD4.

The first to fourth channels CH1 to CH4 may be electrically connected to the third core TSV area 610D. The first to fourth channels CH1 to CH4 may receive, respectively, the third command CMD3 and the third data DATA3 from the third core TSV area 610D. The first to fourth channels CH1 to CH4 may output the third data DATA3 to the third core TSV area 610D. The first to fourth channels CH1 to CH4 may store, respectively, the third data DATA3 after the start of a write operation of an internal operation based on the third command CMD3. The first to fourth channels CH1 to CH4 may output, respectively, the third data DATA3 after the start of a read operation of an internal operation based on the third command CMD3. The first to fourth channels CH1 to CH4 may be set as a first group of channels.

The fifth to eighth CH5 to CH8 may be electrically connected to the fourth core TSV area 620D. The fifth to eighth CH5 to CH8 may receive the fourth command CMD4 and the fourth data DATA4 from the fourth core TSV area 620D. The fifth to eighth CH5 to CH8 may output the fourth data DATA4 to the fourth core TSV area 620D. The fifth to eighth CH5 to CH8 may store, respectively, the fourth data DATA4 after the start of a write operation of an internal operation based on the fourth command CMD4. The fifth to eighth CH5 to CH8 may output, respectively, the fourth data DATA4 after the start of a read operation of an internal operation based on the fourth command CMD4. The fifth to eighth CH5 to CH8 may be set as a second group of channels.

The first to fourth channels CH1 to CH4 may be disposed in a first edge area TOP of the second memory device 600D. The fifth to eighth CH5 to CH8 may be disposed in a second edge area BOTTOM of the second memory device 600D. The first edge area TOP may be disposed in the first direction D1 from a central area CENTER of the second memory device 600D. The second edge area BOTTOM may be disposed in the second direction D2 from the central area CENTER of the second memory device 600D. The first edge area TOP may be set as an upper area of the second memory device 600D in the Y axis. The second edge area BOTTOM may be set as a lower area of the second memory device 600D in the Y axis.

The third core TSV area 610D may be electrically connected to the third base TSV area 521D-3 of the second control device 500D. The third core TSV area 610D may receive the third command CMD3 and the third data DATA3 from the third base TSV area 521D-3. The third core TSV area 610D may receive the third command CMD3 and the third data DATA3 through a plurality of TSVs. The third core TSV area 610D may output the third command CMD3 and the third data DATA3 to the first to fourth channels CH1 to CH4. The third core TSV area 610D may receive the third data DATA3 from the first to fourth channels CH1 to CH4 and output the third data DATA3 to the third base TSV area 521D-3. The third core TSV area 610D may be disposed in the central area CENTER.

The fourth core TSV area 620d may be electrically

connected to the fourth base TSV area 522D-3 of the second control device 500D. The fourth core TSV area 620D may receive the fourth command CMD4 and the fourth data DATA4 from the fourth base TSV area 522D-3. The fourth core TSV area 620D may receive the fourth command CMD4 and the fourth data DATA4 through a plurality of TSVs. The fourth core TSV area 620D may output the fourth command CMD4 and the fourth data DATA4 to the fifth to eighth CH5 to CH8. The fourth core TSV area 620D may receive the fourth data DATA4 from the fifth to eighth CH5 to CH8 and output the fourth data DATA4 to the fourth base TSV area 522D-3. The fourth core TSV area 620D may be disposed in the central area CENTER.

The first to eighth channels CH1 to CH8, the third core TSV area 610D, and the fourth core TSV area 620D included in the second memory device 600D may be disposed at various locations according to an embodiment.

The second memory device 600D may be disposed in a right area RIGHT in the X axis.

As described above, the semiconductor system 9D according to an embodiment of the present disclosure can extend a data capacity that is used in an arithmetic operation because a plurality of HBM devices is electrically connected to different HBM devices and a plurality of HBM devices is electrically connected to the process circuit. In an embodiment, the semiconductor system 9D can rapidly perform an arithmetic operation by increasing the number of HBM devices electrically connected to the process circuit and performing the arithmetic operation. In an embodiment, the semiconductor system 9D can variously set the bandwidth of data by selectively activating a plurality of physical layers (PHY) included in HBM devices. In an embodiment, the semiconductor system 9D can reduce current consumption by selectively activating a plurality of physical layers (PHY) included in HBM devices based on the bandwidth of data.

The third HBM device 23D and the fourth HBM device 24D illustrated in FIG. 1 have the same constructions and perform the same operations as the first HBM device 21D and the second HBM device 22D, respectively, and thus detailed descriptions thereof are omitted. The fifth HBM device 25D and the sixth HBM device 26D illustrated in FIG. 1 have the same constructions and perform the same operations as the first HBM device 21D and the second HBM device 22D, respectively, and thus detailed descriptions thereof are omitted. The seventh HBM device 27D and the eighth HBM device 28D illustrated in FIG. 1 have the same constructions and perform the same operations as the first HBM device 21D and the second HBM device 22D, respectively, and thus detailed descriptions thereof are omitted.

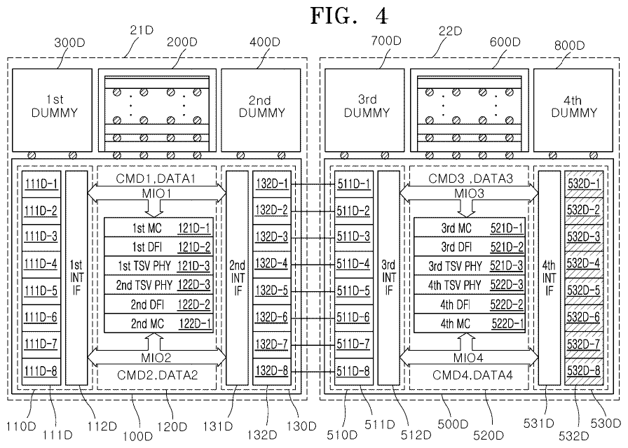

FIG. 4 is a diagram for describing operations of the first HBM device 21D and the second HBM device 22D according to an embodiment of the present disclosure. The operations of the first HBM device 21D and the second HBM device 22D are described with reference to FIG. 4. In this case, a case in which the twenty-fifth to thirty-second physical layers 532D-1 to 532D-8 included in the fourth physical area 532D are deactivated is described as follows as an example.

First, an operation of the first HBM device 21D is described as follows.

The first physical area 111D of the first control device 100D inputs and outputs the first command CMD1, the first data DATA1, the second command CMD2, and the second data DATA2 when the first to eighth physical layers 111D-1 to 111D-8 are activated.

The first internal interface area 112D of the first control device 100D receives the first command CMD1, the first data DATA1, the second command CMD2, and the second data DATA2 from the first physical area 111D. The first internal interface area 112D inputs and outputs the first command CMD1, the first data DATA1, the second command CMD2, and the second data DATA2 through the first and second internal input and output lines MIO1 and MIO2.

The first memory controller 121D-1, first base interface area 121D-2, and first base TSV area 121D-3 of the first control device 100D input and output the first command CMD1 and the first data DATA1 through the first internal input and output line MIO1. The second memory controller 122D-1, the second base interface area 122D-2, and the second base TSV area 122D-3 input and output the second command CMD2 and the second data DATA2 through the second internal input and output line MIO2.

The first memory device 200D disposed in the second predetermined area inputs and outputs the first data DATA1 by performing an internal operation based on the first command CMD1. The first memory device 200D inputs and outputs the second data DATA2 by performing an internal operation based on the second command CMD2.

The second internal interface area 131D of the first control device 100D inputs and outputs the first command CMD1, the first data DATA1, the second command CMD2, and the second data DATA2 through the first and second internal input and output lines MIO1 and MIO2.

The second physical area 132D of the first control device 100D inputs and outputs the first command CMD1, the first data DATA1, the second command CMD2, and the second data DATA2 when the ninth to sixteenth physical layers 132D-1 to 132D-8 are activated.

The first dummy die group 300D disposed in the first predetermined area discharges heat generated from the first area 110D of the first control device 100D.

The second dummy die group 400D disposed in the third predetermined area discharges heat generated from the third area 130D of the first control device 100D.

That is, the first HBM device 21D inputs and outputs the first data DATA1 and the second data DATA2 having a first bandwidth, respectively, when the first to eighth physical layers 111D-1 to 111D-8 and the ninth to sixteenth physical layers 132D-1 to 132D-8 are activated.

Next, an operation of the second HBM device 22D is described as follows.

The third physical area 511D of the second control device 500D receives the first command CMD1, the first data DATA1, the second command CMD2, and the second data DATA2 through the ninth to sixteenth physical layers 132D-1 to 132D-8 when the seventeenth to twenty-fourth physical layers 511D-1 to 511D-8 are activated. The third physical area 511D generates the third command CMD3, the third data DATA3, the fourth command CMD4, and the fourth data DATA4 based on the first command CMD1, the first data DATA1, the second command CMD2, and the second data DATA2 when the seventeenth to twenty-fourth physical layers 511D-1 to 511D-8 are activated. The third physical area 511D inputs and outputs the third command CMD3, the third data DATA3, the fourth command CMD4, and the fourth data DATA4 through the seventeenth to twenty-fourth physical layers 511D-1 to 511D-8.

The third internal interface area 512D of the second control device 500D receives the third command CMD3, the third data DATA3, the fourth command CMD4, and the fourth data DATA4 from the third physical area 511D. The third internal interface area 512D inputs and outputs the third command CMD3, the third data DATA3, the fourth command CMD4, and the fourth data DATA4 through the third and fourth internal input and output lines MIO3 and MIO4.

The third memory controller 521D-1, third base interface area 521D-2, and third base TSV area 521D-3 of the second control device 500D input and output the third command CMD3 and the third data DATA1 through the third internal input and output line MIO3. The fourth memory controller 522D-1, the fourth base interface area 522D-2, and the fourth base TSV area 522D-3 input and output the fourth command CMD4 and the fourth data DATA4 through the fourth internal input and output line MIO4.

The second memory device 600D disposed in the fifth predetermined area inputs and outputs the third data DATA3 by performing an internal operation based on the third command CMD3. The second memory device 600D inputs and outputs the fourth data DATA4 by performing an internal operation based on the fourth command CMD4.

The fourth internal interface area 531D of the second control device 500D inputs and outputs the third command CMD3, the third data DATA3, the fourth command CMD4, and the fourth data DATA4 through the third and fourth internal input and output lines MIO3 and MIO4.

In an embodiment, all of the twenty-fifth to thirty-second physical layers 532D-1 to 532D-8 of the fourth physical area 532D of the second control device 500D are deactivated.

The third dummy die group 700D disposed in the fourth predetermined area discharges heat generated from the fourth area 510D of the second control device 500D.

The fourth dummy die group 800D disposed in the sixth predetermined area discharges heat generated from the sixth area 530D of the second control device 500D when inputting and outputting data as the second HBM device 22D is electrically connected to another HBM device and the twenty-fifth to thirty-second physical layers 532D-1 to 532D-8 of the fourth physical area 532D are activated.

That is, the second HBM device 22D inputs and outputs the third data DATA3 and the fourth data DATA4 having a first bandwidth, respectively, when the seventeenth to twenty-fourth physical layers 511D-1 to 511D-8 are activated.

As described above, the semiconductor system 9D according to an embodiment of the present disclosure can extend a data capacity that is used in an arithmetic operation because a plurality of HBM devices is electrically connected to different HBM devices and a plurality of HBM devices is electrically connected to the process circuit. In an embodiment, the semiconductor system 9D can rapidly perform an arithmetic operation by increasing the number of HBM devices electrically connected to the process circuit and performing the arithmetic operation. In an embodiment, the semiconductor system 9D can variously set the bandwidth of data by selectively activating a plurality of physical layers (PHY) included in HBM devices. In an embodiment, the semiconductor system 9D can reduce current consumption by selectively activating a plurality of physical layers (PHY) included in HBM devices based on the bandwidth of data.

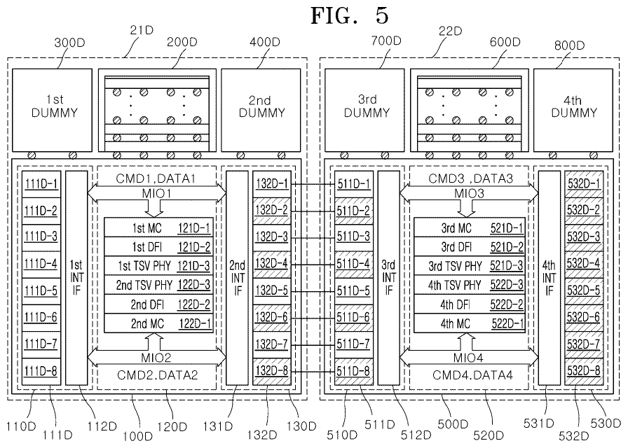

FIG. 5 is a diagram for describing operations of the first HBM device 21D and the second HBM device 22D according to an embodiment of the present disclosure. The operations of the first HBM device 21D and the second HBM device 22D are described with reference to FIG. 5. In this case, a case in which some physical layers, among the first and second groups of physical layers included in the second physical area 132D, some physical layers, among the third and fourth groups of physical layers included in the third physical area 511D, and the twenty-fifth to thirty-second physical layers 532D-1 to 532D-8 included in the fourth physical area 532D are deactivated is described as follows as an example.

First, an operation of the first HBM device 21D is described as follows.

The first physical area 111D of the first control device 100D inputs and outputs the first command CMD1, the first data DATA1, the second command CMD2, and the second data DATA2 when the first to eighth physical layers 111D-1 to 111D-8 are activated.

The first internal interface area 112D of the first control device 100D receives the first command CMD1, the first data DATA1, the second command CMD2, and the second data DATA2 from the first physical area 111D. The first internal interface area 112D inputs and outputs the first command CMD1, the first data DATA1, the second command CMD2, and the second data DATA2 through the first and second internal input and output lines MIO1 and MIO2.

The first memory controller 121D-1, first base interface area 121D-2, and first base TSV area 121D-3 of the first control device 100D input and output the first command CMD1 and the first data DATA1 through the first internal input and output line MIO1. The second memory controller 122D-1, the second base interface area 122D-2, and the second base TSV area 122D-3 input and output the second command CMD2 and the second data DATA2 through the second internal input and output line MIO2.

The first memory device 200D disposed in the second predetermined area inputs and outputs the first data DATA1 by performing an internal operation based on the first command CMD1. The first memory device 200D inputs and outputs the second data DATA2 by performing an internal operation based on the second command CMD2.

The second internal interface area 131D of the first control device 100D inputs and outputs the first command CMD1, the first data DATA1, the second command CMD2, and the second data DATA2 through the first and second internal input and output lines MIO1 and MIO2.

The second physical area 132D of the first control device 100D inputs and outputs the first command CMD1, the first data DATA1, the second command CMD2, and the second data DATA2 as some physical layers 132D-1 and 132D-3, among the first group of physical layers, are activated, some physical layers 132D-5 and 132D-7, among the second group of physical layers, are activated, some physical layers 132D-2 and 132D-4, among the first group of physical layers, are deactivated, and some physical layers 132D-6 and 132D-8, among the second group of physical layers, are deactivated.

The first dummy die group 300D disposed in the first predetermined area discharges heat generated from the first area 110D of the first control device 100D.

The second dummy die group 400D disposed in the third predetermined area discharges heat generated from the third area 130D of the first control device 100D.

That is, the first HBM device 21D inputs and outputs the first data DATA1 and the second data DATA2 having a second bandwidth, respectively, as the first to eighth physical layers 111D-1 to 111D-8, some physical layers 132D-1 and 132D-3, among the first group of physical layers, are activated, and some physical layers 132D-5 and 132D-7, among the second group of physical layers, are activated. The second bandwidth is set as a bandwidth that is ½ of the first bandwidth described with reference to FIG. 4.

Next, an operation of the second HBM device 22D is described as follows.

The third physical area 511D of the second control device 500D receives the first command CMD1, the first data DATA1, the second command CMD2, and the second data DATA2 as some physical layers 511D-1 and 511D-3, among the third group of physical layers, are activated, some physical layers 511D-5 and 511D-7, among the fourth group of physical layers, are activated, some physical layers 511D-2 and 511D-4, among the third group of physical layers, are deactivated, and some physical layers 511D-6 and 511D-8, among the fourth group of physical layers, are deactivated. The third physical area 511D generates the third command CMD3, the third data DATA3, the fourth command CMD4, and the fourth data DATA4, based on the first command CMD1, the first data DATA1, the second command CMD2, and the second data DATA2, as some physical layers 511D-1 and 511D-3, among the third group of physical layers, are activated and some physical layers 511D-5 and 511D-7, among the fourth group of physical layers, are activated. The third physical area 511D inputs and outputs the third command CMD3, the third data DATA3, the fourth command CMD4, and the fourth data DATA4 through some physical layers 511D-1 and 511D-3, among the third group of physical layers, and some physical layers 511D-5 and 511D-7, among the fourth group of physical layers.

The third internal interface area 512D of the second control device 500D receives the third command CMD3, the third data DATA3, the fourth command CMD4, and the fourth data DATA4 from the third physical area 511D. The third internal interface area 512D inputs and outputs the third command CMD3, the third data DATA3, the fourth command CMD4, and the fourth data DATA4 through the third and fourth internal input and output lines MIO3 and MIO4.

The third memory controller 521D-1, third base interface area 521D-2, and third base TSV area 521D-3 of the second control device 500D input and output the third command CMD3 and the third data DATA1 through the third internal input and output line MIO3. The fourth memory controller 522D-1, the fourth base interface area 522D-2, and the fourth base TSV area 522D-3 input and output the fourth command CMD4 and the fourth data DATA4 through the fourth internal input and output line MIO4.

The second memory device 600D disposed in the fifth predetermined area inputs and outputs the third data DATA3 by performing an internal operation based on the third command CMD3. The second memory device 600D inputs and outputs the fourth data DATA4 by performing an internal operation based on the fourth command CMD4.

The fourth internal interface area 531D of the second control device 500D inputs and outputs the third command CMD3, the third data DATA3, the fourth command CMD4, and the fourth data DATA4 through the third and fourth internal input and output lines MIO3 and MIO4.

In an embodiment, all of the twenty-fifth to thirty-second physical layers 532D-1 to 532D-8 of the fourth physical area 532D of the second control device 500D are deactivated.

The third dummy die group 700D disposed in the fourth predetermined area discharges heat generated from the fourth area 510D of the second control device 500D.

The fourth dummy die group 800D disposed in the sixth predetermined area discharges heat generated from the sixth area 530D of the second control device 500D when inputting and outputting data as the second HBM device 22D is electrically connected to another HBM device and the twenty-fifth to thirty-second physical layers 532D-1 to 532D-8 of the fourth physical area 532D are activated.

That is, the second HBM device 22D inputs and outputs the third data DATA3 and the fourth data DATA4 having a second bandwidth, respectively, as some physical layers 511D-1 and 511D-3, among the third group of physical layers, are activated and some physical layers 511D-5 and 511D-7, among the fourth group of physical layers, are activated. The second bandwidth is set as a bandwidth that is ½ of the first bandwidth described with reference to FIG. 4.

As described above, the semiconductor system 9D according to an embodiment of the present disclosure can extend a data capacity that is used in an arithmetic operation because a plurality of HBM devices is electrically connected to different HBM devices and a plurality of HBM devices is electrically connected to the process circuit. In an embodiment, the semiconductor system 9D can rapidly perform an arithmetic operation by increasing the number of HBM devices electrically connected to the process circuit and performing the arithmetic operation. In an embodiment, the semiconductor system 9D can variously set the bandwidth of data by selectively activating a plurality of physical layers (PHY) included in HBM devices. In an embodiment, the semiconductor system 9D can reduce current consumption by selectively activating a plurality of physical layers (PHY) included in HBM devices based on the bandwidth of data.

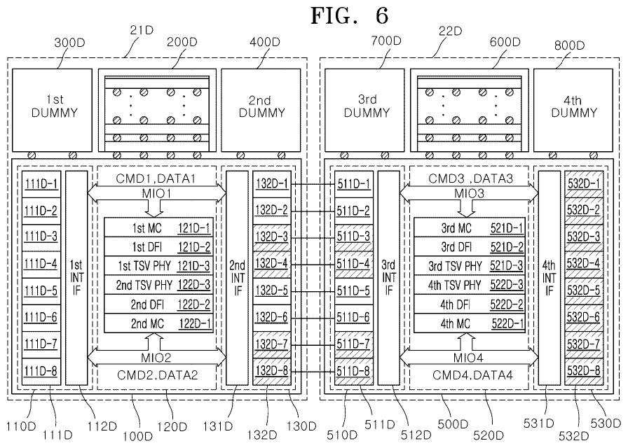

FIG. 6 is a diagram for describing operations of the first HBM device 21D and the second HBM device 22D according to an embodiment of the present disclosure. The operations of the first HBM device 21D and the second HBM device 22D are described with reference to FIG. 6. In this case, a case in which some physical layers, among the first and second groups of physical layers included in the second physical area 132D, some physical layers, among the third and fourth groups of physical layers included in the third physical area 511D, and the twenty-fifth to thirty-second physical layers 532D-1 to 532D-8 included in the fourth physical area 532D are deactivated is described as follows as an example.

First, an operation of the first HBM device 21D is described as follows.

The first physical area 111D of the first control device 100D inputs and outputs the first command CMD1, the first data DATA1, the second command CMD2, and the second data DATA2 when the first to eighth physical layers 111D-1 to 111D-8 are activated.

The first internal interface area 112D of the first control device 100D receives the first command CMD1, the first data DATA1, the second command CMD2, and the second data DATA2 from the first physical area 111D. The first internal interface area 112D inputs and outputs the first command CMD1, the first data DATA1, the second command CMD2, and the second data DATA2 through the first and second internal input and output lines MIO1 and MIO2.

The first memory controller 121D-1, first base interface area 121D-2, and first base TSV area 121D-3 of the first control device 100D input and output the first command CMD1 and the first data DATA1 through the first internal input and output line MIO1. The second memory controller 122D-1, the second base interface area 122D-2, and the second base TSV area 122D-3 input and output the second command CMD2 and the second data DATA2 through the second internal input and output line MIO2.

The first memory device 200D disposed in the second predetermined area inputs and outputs the first data DATA1 by performing an internal operation based on the first command CMD1. The first memory device 200D inputs and outputs the second data DATA2 by performing an internal operation based on the second command CMD2.

The second internal interface area 131D of the first control device 100D inputs and outputs the first command CMD1, the first data DATA1, the second command CMD2, and the second data DATA2 through the first and second internal input and output lines MIO1 and MIO2.

The second physical area 132D of the first control device 100D inputs and outputs the first command CMD1, the first data DATA1, the second command CMD2, and the second data DATA2 as some physical layers 132D-1 and 132D-2, among the first group of physical layers, are activated, some physical layers 132D-5 and 132D-6, among the second group of physical layers, are activated, some physical layers 132D-3 and 132D-4, among the first group of physical layers, are deactivated, and some physical layers 132D-7 and 132D-8, among the second group of physical layers, are deactivated.

The first dummy die group 300D disposed in the first predetermined area discharges heat generated from the first area 110D of the first control device 100D.

The second dummy die group 400D disposed in the third predetermined area discharges heat generated from the third area 130D of the first control device 100D.

That is, the first HBM device 21D inputs and outputs the first data DATA1 and the second data DATA2 having a second bandwidth, respectively, as the first to eighth physical layers 111D-1 to 111D-8 and some physical layers 132D-1, 132D-2, 132D-5, and 132D-6, among the first group of physical layers, are activated. The second bandwidth is set as a bandwidth that is ½ of the first bandwidth described with reference to FIG. 4.

Next, an operation of the second HBM device 22D is described as follows.

The third physical area 511D of the second control device 500D receives the first command CMD1, the first data DATA1, the second command CMD2, and the second data DATA2 as some physical layers 511D-1 and 511D-2, among the third group of physical layers, are activated, some physical layers 511D-5 and 511D-6, among the fourth group of physical layers, are activated, some physical layers 511D-3 and 511D-4, among the third group of physical layers, are deactivated, and some physical layers 511D-7 and 511D-8, among the fourth group of physical layers, are deactivated. The third physical area 511D generates the third command CMD3, the third data DATA3, the fourth command CMD4, and the fourth data DATA4, based on the first command CMD1, the first data DATA1, the second command CMD2, and the second data DATA2, as some physical layers 511D-1 and 511D-2, among the third group of physical layers, are activated and some physical layers 511D-5 and 511D-6, among the fourth group of physical layers, are activated. The third physical area 511D inputs and outputs the third command CMD3, the third data DATA3, the fourth command CMD4, and the fourth data DATA4 through some physical layers 511D-1 and 511D-2, among the third group of physical layers, and some physical layers 511D-5 and 511D-6, among the fourth group of physical layers.

The third internal interface area 512D of the second control device 500D receives the third command CMD3, the third data DATA3, the fourth command CMD4, and the fourth data DATA4 from the third physical area 511D. The third internal interface area 512D inputs and outputs the third command CMD3, the third data DATA3, the fourth command CMD4, and the fourth data DATA4 through the third and fourth internal input and output lines MIO3 and MIO4.

The third memory controller 521D-1, third base interface area 521D-2, and third base TSV area 521D-3 of the second control device 500D input and output the third command CMD3 and the third data DATA1 through the third internal input and output line MIO3. The fourth memory controller 522D-1, the fourth base interface area 522D-2, and the fourth base TSV area 522D-3 input and output the fourth command CMD4 and the fourth data DATA4 through the fourth internal input and output line MIO4.

The second memory device 600D disposed in the fifth predetermined area inputs and outputs the third data DATA3 by performing an internal operation based on the third command CMD3. The second memory device 600D inputs and outputs the fourth data DATA4 by performing an internal operation based on the fourth command CMD4.

The fourth internal interface area 531D of the second control device 500D inputs and outputs the third command CMD3, the third data DATA3, the fourth command CMD4, and the fourth data DATA4 through the third and fourth internal input and output lines MIO3 and MIO4.

In an embodiment, all of the twenty-fifth to thirty-second physical layers 532D-1 to 532D-8 of the fourth physical area 532D of the second control device 500D are deactivated.

The third dummy die group 700D disposed in the fourth predetermined area discharges heat generated from the fourth area 510D of the second control device 500D.

The fourth dummy die group 800D disposed in the sixth predetermined area discharges heat generated from the sixth area 530D of the second control device 500D when inputting and outputting data as the second HBM device 22D is electrically connected to another HBM device and the twenty-fifth to thirty-second physical layers 532D-1 to 532D-8 of the fourth physical area 532D are activated.

That is, the second HBM device 22D inputs and outputs the third data DATA3 and the fourth data DATA4 having a second bandwidth, respectively, as some physical layers 511D-1 and 511D-2, among the third group of physical layers, are activated and some physical layers 511D-5 and 511D-6, among the fourth group of physical layers, are activated. The second bandwidth is set as a bandwidth that is ½ of the first bandwidth described with reference to FIG. 4.

As described above, the semiconductor system 9D according to an embodiment of the present disclosure can extend a data capacity that is used in an arithmetic operation because a plurality of HBM devices is electrically connected to different HBM devices and a plurality of HBM devices is electrically connected to the process circuit. In an embodiment, the semiconductor system 9D can rapidly perform an arithmetic operation by increasing the number of HBM devices electrically connected to the process circuit and performing the arithmetic operation. In an embodiment, the semiconductor system 9D can variously set the bandwidth of data by selectively activating a plurality of physical layers (PHY) included in HBM devices. In an embodiment, the semiconductor system 9D can reduce current consumption by selectively activating a plurality of physical layers (PHY) included in HBM devices based on the bandwidth of data.

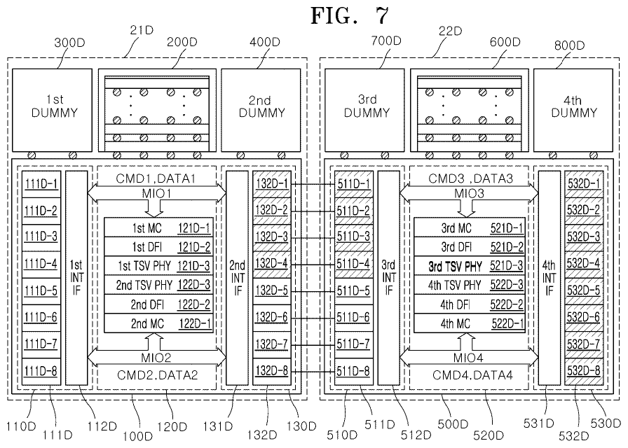

FIG. 7 is a diagram for describing operations of the first HBM device 21D and the second HBM device 22D according to an embodiment of the present disclosure. The operations of the first HBM device 21D and the second HBM device 22D are described with reference to FIG. 7. In this case, a case in which the first group of physical layers included in the second physical area 132D, the third group of physical layers included in the third physical area 511D, and the twenty-fifth to thirty-second physical layers 532D-1 to 532D-8 included in the fourth physical area 532D are deactivated is described as follows as an example.

First, an operation of the first HBM device 21D is described as follows.

The first physical area 111D of the first control device 100D inputs and outputs the first command CMD1, the first data DATA1, the second command CMD2, and the second data DATA2 when the first to eighth physical layers 111D-1 to 111D-8 are activated.

The first internal interface area 112D of the first control device 100D receives the first command CMD1, the first data DATA1, the second command CMD2, and the second data DATA2 from the first physical area 111D. The first internal interface area 112D inputs and outputs the first command CMD1, the first data DATA1, the second command CMD2, and the second data DATA2 through the first and second internal input and output lines MIO1 and MIO2.

The first memory controller 121D-1, first base interface area 121D-2, and first base TSV area 121D-3 of the first control device 100D input and output the first command CMD1 and the first data DATA1 through the first internal input and output line MIO1. The second memory controller 122D-1, the second base interface area 122D-2, and the second base TSV area 122D-3 input and output the second command CMD2 and the second data DATA2 through the second internal input and output line MIO2.

The first memory device 200D disposed in the second predetermined area inputs and outputs the first data DATA1 by performing an internal operation based on the first command CMD1. The first memory device 200D inputs and outputs the second data DATA2 by performing an internal operation based on the second command CMD2.

The second internal interface area 131D of the first control device 100D inputs and outputs the first command CMD1, the first data DATA1, the second command CMD2, and the second data DATA2 through the first and second internal input and output lines MIO1 and MIO2.

The second physical area 132D of the first control device 100D inputs and outputs the first command CMD1, the first data DATA1, the second command CMD2, and the second data DATA2 as the second group of physical layers 132D-5, 132D-6, 132D-7, and 132D-8 is activated and the first group of physical layers 132D-1, 132D-2, 132D-3, and 132D-4 is deactivated.

The first dummy die group 300D disposed in the first predetermined area discharges heat generated from the first area 110D of the first control device 100D.

The second dummy die group 400D disposed in the third predetermined area discharges heat generated from the third area 130D of the first control device 100D.

That is, the first HBM device 21D inputs and outputs the first data DATA1 and the second data DATA2 having a second bandwidth, respectively, as the first to eighth physical layers 111D-1 to 111D-8 and the second group of physical layers 132D-5, 132D-6, 132D-7, and 132D-8 are activated. The second bandwidth is set as a bandwidth that is ½ of the first bandwidth described with reference to FIG. 4.

Next, an operation of the second HBM device 22D is described as follows.

The third physical area 511D of the second control device 500D receives the first command CMD1, the first data DATA1, the second command CMD2, and the second data DATA2 as the fourth group of physical layers 511D-5, 511D-6, 511D-7, and 511D-8 is activated and the third group of physical layers 511D-1, 511D-2, 511D-3, and 511D-4 is deactivated. The third physical area 511D generates the third command CMD3, the third data DATA3, the fourth command CMD4, and the fourth data DATA4, based on the first command CMD1, the first data DATA1, the second command CMD2, and the second data DATA2, as the fourth group of physical layers 511D-5, 511D-6, 511D-7, and 511D-8 is activated. The third physical area 511D inputs and outputs the third command CMD3, the third data DATA3, the fourth command CMD4, and the fourth data DATA4 through the fourth group of physical layers 511D-5, 511D-6, 511D-7, and 511D-8.

The third internal interface area 512D of the second control device 500D receives the third command CMD3, the third data DATA3, the fourth command CMD4, and the fourth data DATA4 from the third physical area 511D. The third internal interface area 512D inputs and outputs the third command CMD3, the third data DATA3, the fourth command CMD4, and the fourth data DATA4 through the third and fourth internal input and output lines MIO3 and MIO4.

The third memory controller 521D-1, third base interface area 521D-2, and third base TSV area 521D-3 of the second control device 500D input and output the third command CMD3 and the third data DATA1 through the third internal input and output line MIO3. The fourth memory controller 522D-1, the fourth base interface area 522D-2, and the fourth base TSV area 522D-3 input and output the fourth command CMD4 and the fourth data DATA4 through the fourth internal input and output line MIO4.

The second memory device 600D disposed in the fifth predetermined area inputs and outputs the third data DATA3 by performing an internal operation based on the third command CMD3. The second memory device 600D inputs and outputs the fourth data DATA4 by performing an internal operation based on the fourth command CMD4.

The fourth internal interface area 531D of the second control device 500D inputs and outputs the third command CMD3, the third data DATA3, the fourth command CMD4, and the fourth data DATA4 through the third and fourth internal input and output lines MIO3 and MIO4.

In an embodiment, all of the twenty-fifth to thirty-second physical layers 532D-1 to 532D-8 of the fourth physical area 532D of the second control device 500D are deactivated.

The third dummy die group 700D disposed in the fourth predetermined area discharges heat generated from the fourth area 510D of the second control device 500D.

The fourth dummy die group 800D disposed in the sixth predetermined area discharges heat generated from the sixth area 530D of the second control device 500D when inputting and outputting data as the second HBM device 22D is electrically connected to another HBM device and the twenty-fifth to thirty-second physical layers 532D-1 to 532D-8 of the fourth physical area 532D are activated.

That is, the second HBM device 22D inputs and outputs the third data DATA3 and the fourth data DATA4 having a second bandwidth, respectively, as the fourth group of physical layers 511D-5, 511D-6, 511D-7, and 511D-8 is activated. The second bandwidth is set as a bandwidth that is ½ of the first bandwidth described with reference to FIG. 4.

As described above, the semiconductor system 9D according to an embodiment of the present disclosure can extend a data capacity that is used in an arithmetic operation because a plurality of HBM devices is electrically connected to different HBM devices and a plurality of HBM devices is electrically connected to the process circuit. In an embodiment, the semiconductor system 9D can rapidly perform an arithmetic operation by increasing the number of HBM devices electrically connected to the process circuit and performing the arithmetic operation. In an embodiment, the semiconductor system 9D can variously set the bandwidth of data by selectively activating a plurality of physical layers (PHY) included in HBM devices. In an embodiment, the semiconductor system 9D can reduce current consumption by selectively activating a plurality of physical layers (PHY) included in HBM devices based on the bandwidth of data.

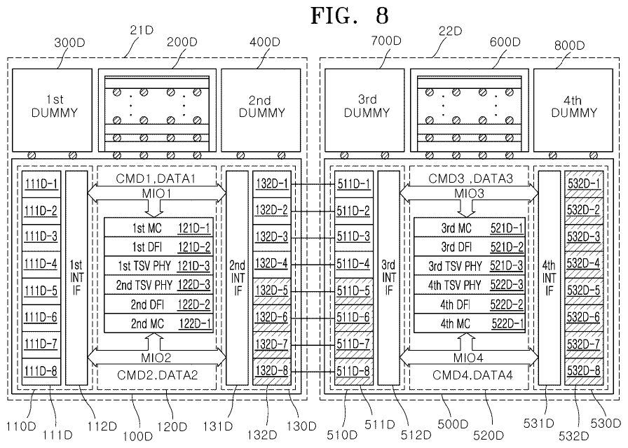

FIG. 8 is a diagram for describing operations of the first HBM device 21D and the second HBM device 22D according to an embodiment of the present disclosure. The operations of the first HBM device 21D and the second HBM device 22D are described with reference to FIG. 8. In this case, a case in which the second group of physical layers included in the second physical area 132D, the fourth group of physical layers included in the third physical area 511D, and the twenty-fifth to thirty-second physical layers 532D-1 to 532D-8 included in the fourth physical area 532D are deactivated is described as follows as an example.

First, an operation of the first HBM device 21D is described as follows.

The first physical area 111D of the first control device 100D inputs and outputs the first command CMD1, the first data DATA1, the second command CMD2, and the second data DATA2 when the first to eighth physical layers 111D-1 to 111D-8 are activated.

The first internal interface area 112D of the first control device 100D receives the first command CMD1, the first data DATA1, the second command CMD2, and the second data DATA2 from the first physical area 111D. The first internal interface area 112D inputs and outputs the first command CMD1, the first data DATA1, the second command CMD2, and the second data DATA2 through the first and second internal input and output lines MIO1 and MIO2.

The first memory controller 121D-1, first base interface area 121D-2, and first base TSV area 121D-3 of the first control device 100D input and output the first command CMD1 and the first data DATA1 through the first internal input and output line MIO1. The second memory controller 122D-1, the second base interface area 122D-2, and the second base TSV area 122D-3 input and output the second command CMD2 and the second data DATA2 through the second internal input and output line MIO2.

The first memory device 200D disposed in the second predetermined area inputs and outputs the first data DATA1 by performing an internal operation based on the first command CMD1. The first memory device 200D inputs and outputs the second data DATA2 by performing an internal operation based on the second command CMD2.

The second internal interface area 131D of the first control device 100D inputs and outputs the first command CMD1, the first data DATA1, the second command CMD2, and the second data DATA2 through the first and second internal input and output lines MIO1 and MIO2.

The second physical area 132D of the first control device 100D inputs and outputs the first command CMD1, the first data DATA1, the second command CMD2, and the second data DATA2 as the first group of physical layers 132D-1, 132D-2, 132D-3, and 132D-4 is activated and the second group of physical layers 132D-5, 132D-6, 132D-7, and 132D-8 is deactivated.

The first dummy die group 300D disposed in the first predetermined area discharges heat generated from the first area 110D of the first control device 100D.

The second dummy die group 400D disposed in the third predetermined area discharges heat generated from the third area 130D of the first control device 100D.

That is, the first HBM device 21D inputs and outputs the first data DATA1 and the second data DATA2 having a second bandwidth, respectively, as the first to eighth physical layers 111D-1 to 111D-8 and the first group of physical layers 132D-1, 132D-2, 132D-3, and 132D-4 are activated. The second bandwidth is set as a bandwidth that is ½ of the first bandwidth described with reference to FIG. 4.

Next, an operation of the second HBM device 22D is described as follows.

The third physical area 511D of the second control device 500D receives the first command CMD1, the first data DATA1, the second command CMD2, and the second data DATA2 as the third group of physical layers 511D-1, 511D-2, 511D-3, and 511D-4 is activated and the fourth group of physical layers 511D-5, 511D-6, 511D-7, and 511D-8 is deactivated. The third physical area 511D generates the third command CMD3, the third data DATA3, the fourth command CMD4, and the fourth data DATA4, based on the first command CMD1, the first data DATA1, the second command CMD2, and the second data DATA2, as the third group of physical layers 511D-1, 511D-2, 511D-3, and 511D-4 is activated. The third physical area 511D inputs and outputs the third command CMD3, the third data DATA3, the fourth command CMD4, and the fourth data DATA4 through the third group of physical layers 511D-1, 511D-2, 511D-3, and 511D-4.

The third internal interface area 512D of the second control device 500D receives the third command CMD3, the third data DATA3, the fourth command CMD4, and the fourth data DATA4 from the third physical area 511D. The third internal interface area 512D inputs and outputs the third command CMD3, the third data DATA3, the fourth command CMD4, and the fourth data DATA4 through the third and fourth internal input and output lines MIO3 and MIO4.

The third memory controller 521D-1, third base interface area 521D-2, and third base TSV area 521D-3 of the second control device 500D input and output the third command CMD3 and the third data DATA1 through the third internal input and output line MIO3. The fourth memory controller 522D-1, the fourth base interface area 522D-2, and the fourth base TSV area 522D-3 input and output the fourth command CMD4 and the fourth data DATA4 through the fourth internal input and output line MIO4.

The second memory device 600D disposed in the fifth predetermined area inputs and outputs the third data DATA3 by performing an internal operation based on the third command CMD3. The second memory device 600D inputs and outputs the fourth data DATA4 by performing an internal operation based on the fourth command CMD4.

The fourth internal interface area 531D of the second control device 500D inputs and outputs the third command CMD3, the third data DATA3, the fourth command CMD4, and the fourth data DATA4 through the third and fourth internal input and output lines MIO3 and MIO4.

In an embodiment, all of the twenty-fifth to thirty-second physical layers 532D-1 to 532D-8 of the fourth physical area 532D of the second control device 500D are deactivated.

The third dummy die group 700D disposed in the fourth predetermined area discharges heat generated from the fourth area 510D of the second control device 500D.

The fourth dummy die group 800D disposed in the sixth predetermined area discharges heat generated from the sixth area 530D of the second control device 500D when inputting and outputting data as the second HBM device 22D is electrically connected to another HBM device and the twenty-fifth to thirty-second physical layers 532D-1 to 532D-8 of the fourth physical area 532D are activated.

That is, the second HBM device 22D inputs and outputs the third data DATA3 and the fourth data DATA4 having a second bandwidth, respectively, as the third group of physical layers 511D-1, 511D-2, 511D-3, and 511D-4 is activated. The second bandwidth is set as a bandwidth that is ½ of the first bandwidth described with reference to FIG. 4.

As described above, the semiconductor system 9D according to an embodiment of the present disclosure can extend a data capacity that is used in an arithmetic operation because a plurality of HBM devices is electrically connected to different HBM devices and a plurality of HBM devices is electrically connected to the process circuit. In an embodiment, the semiconductor system 9D can rapidly perform an arithmetic operation by increasing the number of HBM devices electrically connected to the process circuit and performing the arithmetic operation. In an embodiment, the semiconductor system 9D can variously set the bandwidth of data by selectively activating a plurality of physical layers (PHY) included in HBM devices. In an embodiment, the semiconductor system 9D can reduce current consumption by selectively activating a plurality of physical layers (PHY) included in HBM devices based on the bandwidth of data.

What is claimed is:

1. A semiconductor system comprising:
a first high bandwidth memory (HBM) device comprising a first physical area and a second physical area;
a second HBM device comprising a third physical area and a fourth physical area; and
a process circuit electrically connected to the first physical area,
wherein the second physical area of the first HBM device and the third physical area of the second HBM device are electrically connected, and the fourth physical area is deactivated.

2. The semiconductor system of claim 1, wherein the first HBM device and the second HBM device are connected to the process circuit in common through the first physical area, the second physical area, and the third physical area.

3. The semiconductor system of claim 1, wherein the process circuit performs an arithmetic operation on data that is input to and output from the first HBM device and the second HBM device that are connected to the process circuit in common.

4. The semiconductor system of claim 1, wherein the first HBM device comprises:
a first control device comprising a first area, a second area, and a third area and configured to input and output first data and second data to and from the first to third areas;
a first memory device vertically stacked on a second predetermined area that is set in an upper part of the second area and configured to input and output the first data and the second data to and from the second area;
a first dummy die group disposed in a first predetermined area that is set in an upper part of the first area; and
a second dummy die group disposed in a third predetermined area that is set in an upper part of the third area.

5. The semiconductor system of claim 4, wherein the first area comprises:
the first physical area configured to input and output the first data and the second data; and
a first internal interface area electrically connected to the first physical area and first and second internal input and output lines and configured to input and output the first data and the second data.

6. The semiconductor system of claim 4, wherein the second area comprises:
a first internal input and output line configured to input and output the first data; and
a second internal input and output line configured to input and output the second data.

7. The semiconductor system of claim 4, wherein the third area comprises:
a second internal interface area electrically connected to first and second internal input and output lines and configured to input and output the first data and the second data; and
the second physical area electrically connected to the second internal interface area and configured to input and output the first data and the second data.

8. The semiconductor system of claim 1, wherein the second HBM device comprises:
a second control device comprising a fourth area, a fifth area, and a sixth area and configured to input and output third data and fourth data to and from the fourth to sixth areas;
a second memory device vertically stacked on a fifth predetermined area that is set in an upper part of the fifth area and configured to input and output the third data and the fourth data to and from the fifth area;
a third dummy die group disposed in a fourth predetermined area that is set in an upper part of the fourth area; and
a fourth dummy die group disposed in a sixth predetermined area that is set in an upper part of the sixth area.

9. The semiconductor system of claim 8, wherein the fourth area comprises:
the third physical area configured to generate the third data and the fourth data from first data and second data and configured to input and output the third data and the fourth data; and
a second internal interface area electrically connected to the third physical area and third and fourth internal input and output lines and configured to input and output the third data and the fourth data.

10. The semiconductor system of claim 8, wherein the fifth area comprises:
a third internal input and output line configured to input and output the third data; and
a fourth internal input and output line configured to input and output the fourth data.

11. The semiconductor system of claim 8, wherein the sixth area comprises:
a third internal interface area electrically connected to third and fourth internal input and output lines and configured to input and output the third data and the fourth data; and
the fourth physical area electrically connected to the third internal interface area.

12. A semiconductor system comprising:
a first high bandwidth memory (HBM) device, comprising a first physical area comprising a first group of physical layers and a second group of physical layers and a second physical area comprising a third group of physical layers and a fourth group of physical layers; and
a second HBM device, comprising a third physical area comprising a fifth group of physical layers and a sixth group of physical layers and a fourth physical area comprising a seventh group of physical layers and an eighth group of physical layers,
wherein the first to eighth groups of physical layers are selectively activated.

13. The semiconductor system of claim 12, wherein when the first group of physical layers, the second group of physical layers, the third group of physical layers, and the fourth group of physical layers are activated, the first HBM device is configured to input and output first data and second data through a first bandwidth, respectively.

14. The semiconductor system of claim 12, wherein when the first group of physical layers and the second group of physical layers are activated, the third group of physical layers is activated, and the fourth group of physical layers are deactivated, the first HBM device is configured to input and output first data and second data through a second bandwidth, respectively.

15. The semiconductor system of claim 12, wherein when the fifth group of physical layers and the sixth group of physical layers are activated and the seventh group of physical layers and the eighth group of physical layers are deactivated, the second HBM device is configured to input and output third data and fourth data through a first bandwidth, respectively.

16. The semiconductor system of claim 12, wherein when the fifth group of physical layers are activated, the sixth group of physical layers are deactivated, and the seventh group of physical layers and the eighth group of physical layers are deactivated, the second HBM device is configured to input and output third data and fourth data through a second bandwidth, respectively.

17. The semiconductor system of claim 12, wherein when the seventh group of physical layers and the eighth group of physical layers are selectively activated, the second HBM device is connected to a third HBM device and is configured to input and output third data and fourth data.

18. The semiconductor system of claim 17, wherein when the seventh group of physical layers and the eighth group of physical layers are deactivated, the connection of the second HBM device to the third HBM device is disconnected.

19. The semiconductor system of claim 17, wherein when the seventh group of physical layers and the eighth group of physical layers are activated, the second HBM device is configured to input and output the third data and the fourth data through a first bandwidth, respectively.

20. The semiconductor system of claim 17, wherein when the seventh group of physical layers are activated and the eighth group of physical layers are deactivated, the second HBM device is configured to input and output the third data and the fourth data through a second bandwidth, respectively.

21. The semiconductor system of claim 12, wherein the first HBM device further comprises:
a first internal interface area electrically connected to the first physical area and first and second internal input and output lines and configured to input and output first data and second data; and
a second internal interface area electrically connected to the first and second internal input and output lines and the second physical area and configured to input and output the first data and the second data.

22. The semiconductor system of claim 21, wherein the first HBM device further comprises:
a first memory controller electrically connected to the first internal input and output line and configured to input and output the first data;
a first base interface area electrically connected to the first memory controller and configured to input and output the first data; and
a first base TSV area electrically connected to the first base interface area and configured to input and output the first data.

23. The semiconductor system of claim 22, wherein the first HBM device further comprises a first memory device electrically connected to the first base TSV area and configured to input and output the first data.

24. The semiconductor system of claim 23, wherein the first memory device comprises:
a first core TSV area electrically connected to the first base TSV area and configured to input and output the first data; and
a first group of channels electrically connected to the first core TSV area and configured to input and output the first data.

25. The semiconductor system of claim 12, wherein the second HBM device further comprises:
a third internal interface area electrically connected to the third physical area and third and fourth internal input and output lines and configured to input and output third data and fourth data; and
a fourth internal interface area electrically connected to the third and fourth internal input and output lines and the fourth physical area and configured to input and output the third data and the fourth data.

26. The semiconductor system of claim 25, wherein the second HBM device further comprises:
a second memory controller electrically connected to the fourth internal input and output line and configured to input and output the fourth data generated from second data;
a second base interface area electrically connected to the second memory controller and configured to input and output the fourth data; and
a second base TSV area electrically connected to the second base interface area and configured to input and output the fourth data.

27. The semiconductor system of claim 26, wherein the second HBM device further comprises a second memory device electrically connected to the second base TSV area and configured to input and output the fourth data.

28. The semiconductor system of claim 27, wherein the second memory device comprises:
a second core TSV area electrically connected to the second base TSV area and configured to input and output the fourth data; and
a second group of channels electrically connected to the second core TSV area and configured to input and output the fourth data.
